(19) United States
(12) Patent Application Publication
(10) Pub. No.: US 2016/0228994 A1
(43) Pub. Date: Aug. 11, 2016

(54) METHOD AND DEVICE FOR REMOVING AT LEAST PART OF A SEA PLATFORM

(71) Applicant: Heerema Marine Contractors Nederland SE, Leiden (NL)

(72) Inventor: Giuliano GANDOLFI, Leiden (NL)

(21) Appl. No.: 15/021,576

(22) PCT Filed: Sep. 9, 2014
(86) PCT No.: PCT/NL2014/050616

§ 371 Date: Mar. 11, 2016

(30) Foreign Application Priority Data
Sep. 11, 2013 (NL) 2011425

(51) Int. Cl. B23K 28/00; E02B 17/00

(52) U.S. Cl. CPC B23K 28/00; E02B 17/00; E02B 2017/0052; B23K 2201/24

(57) ABSTRACT

Method for removing at least part of a sea platform comprising a support structure with at least one cylindrical support beam located under water, which method comprises the steps of; providing a device for cutting one of the at least one cylindrical support beams, attaching the device in the circular configuration under water to one of the at least one cylindrical support beams with the fastener, wherein the nozzle openings of the molten metal jet cutting units are directed to and at least partly surround said cylindrical support beam, igniting the fuel material of the molten metal jet cutting units with the igniter to cut said surrounded cylindrical support beam with the molten metal jetted out of the nozzle openings, lifting the disconnected part of a platform to be removed with a removal vessel provided near the support structure, and transporting the disconnected part of the sea platform to be removed to a different location.

### FIELD OF THE INVENTION

The invention relates to a method for removing at least part of a sea platform comprising a support structure with at least one cylindrical support beam located under water.

In a known method, explosives are attached to one or more support beams in order to cut them. All vessels located near the support structure need to be transported to a location at a safe distance before the explosives are activated.

In some cases, all the support beams that need to be cut to disconnect the part of the sea platform to be removed are cut by explosives. As a result of this, the support structure will (partly) collapse. A crane vessel will need to pick the disconnected part from the seabed, so that it can be transported to a different location.

In general, not all the support beams that need to be cut to disconnect the part of the sea platform to be removed are cut by explosives. After said support beams are cut by the explosives, the support structure remains in its upright position. The vessel is sailed back to the support structure, and the rest of the support beams that needs to be cut to disconnect the part of the sea platform to be removed are subsequently cut in a different manner, such by diamond wire cutting, or water jet cutting. This way of cutting cylindrical support beams is a time consuming process.

A drawback of the use of explosives is that a high shock wave is produced when the explosives are activated. This produces high subsea noise, which can harm and disturb the sea fauna. The shockwave can also damage the flora and fauna of the surroundings. Some countries therefore do not allow the use of explosives or require that additional measurements are taken to damp the shockwave. These additional measurements do in general not function well and are expensive, amongst others due to the extra time required to install them properly. It is also possible that the shockwave damages a vessel which has not taken sufficient distance.

There are strict hazard material regulations, which make it difficult and complex to handle and store explosives, both onshore as offshore.

Other techniques used for cutting the support beams are diamond wire cutting, water jet cutting, and shear cutting. These techniques are relatively time consuming.

### BACKGROUND OF THE INVENTION

The invention is based on the insight that there is a need in the field of the art for a relatively environmental friendly method for removing at least part of a sea platform comprising a support structure with at least one cylindrical support beam located under water.

The invention is furthermore based on the insight that there is a need in the field of the art for a method of removing at least part of a sea platform comprising a support structure with at least one cylindrical support beam located under water in an efficient manner, and wherein the vessels can remain near the support structure.

### SUMMARY OF THE INVENTION

The invention has the objective to provide an improved or alternative method for removing at least part of a sea platform comprising a support structure with at least one cylindrical support beam located under water.

The present invention furthermore aims to provide an improved or alternative device for cutting a cylindrical support beam which forms part of a support structure of a sea platform under water.

The invention relates to a method for removing at least part of a sea platform comprising a support structure with at least one cylindrical support beam located under water, which method comprises the steps of;
A. providing a device for cutting one of the at least one cylindrical support beams, said device comprising a plurality of molten metal jet cutting units to cut the cylindrical support beam, wherein each of the molten metal jet cutting units comprises a housing surrounding a fuel chamber filed with a fuel material, and a duct connecting the fuel chamber with a nozzle opening, which device comprises a cutting unit holder holding the plurality of molten metal jet cutting units to allow the positioning of the molten metal jet cutting units in a circular configuration in which the nozzle openings are directed to a centre of the circular configuration, wherein the device comprises a fastener to attach the molten metal jet cutting units in the circular configuration to the cylindrical support beam, and an igniter operatively connected to the molten metal jet cutting units to ignite the fuel material so that molten metal is jetted out of the nozzle openings,
B. attaching the device in the circular configuration under water to one of the at least one cylindrical support beams with the fastener, wherein the nozzle openings of the molten metal jet cutting units are directed to and at least partly surround said cylindrical support beam,
C. igniting the fuel material of the molten metal jet cutting units with the igniter to cut said surrounded cylindrical support beam with the molten metal jetted out of the nozzle openings, D. lifting the disconnected part of the sea platform to be removed with a removal vessel provided near the support structure, and
E. transporting the disconnected part of the sea platform to be removed to a different location.

The method according the invention produces a relatively small shock wave. Said method can therefore be considered to be more environmental friendly when compared with the use of explosives. This furthermore allows vessels to be near the support structure during the cutting of the support beams. This tends to make the method more time efficient when compared with the use of explosives.

In an embodiment of the method according to the invention, the method comprises before step C providing the removal vessel near the support structure and connecting the part of the sea platform to be removed to the removal vessel.

In an embodiment of the method according to the invention, the provided removal vessel comprises a crane and the method comprises attaching the crane to the part of the sea platform to be removed.

In an embodiment of the method according to the invention, the provided removal vessel comprises at least one support arm and the method comprises placing the at least one support arm under and in contact with at least part of the part of the sea platform to be removed.

In an embodiment of the method according to the invention, during step C, the removal vessel remains connected to the part of the sea platform to be removed.

In an embodiment of the method according to the invention, during step C, the removal vessel carries at least part of the weight of the part of the sea platform to be removed.

In an embodiment of the method according to the invention, the method comprises creating a continuous cut around the cylindrical support beam in step C.

In an embodiment of the method according to the invention, the steps A, B, and C are performed on multiple support beams of the support structure before the steps D and E are performed.

In an embodiment of the method according to the invention, step C is performed simultaneously on the multiple support beams.

In an embodiment of the method according to the invention, step C is not performed simultaneously on the multiple support beams.

In an embodiment of the method according to the invention, between the steps C and D, at least one support beam is cut with a different cutting technique, such as with diamond wire cutting, water jet cutting, or shear cutting, in order to complete the disconnection of the part of the sea platform to be removed.

In an embodiment of the method according to the invention, before step C, the support beam to which the device is attached has been partly cut with a different cutting technique, such as with diamond wire cutting, water jet cutting, or shear cutting.

In an embodiment of the method according to the invention, in the circular configuration, the nozzle openings of the molten metal jet cutting units of the provided device are positioned to fully surround the support beam and in step C a continuous cut around the entire cylindrical support beam is created with the molten metal jet cutting units.

In an embodiment of the method according to the invention, in the circular configuration, nozzle openings of the molten metal jet cutting units of the provided device are positioned to partly surround the support beam and in step C a continuous cut around part of the cylindrical support beam is created with the molten metal jet cutting units.

In an embodiment of the method according to the invention, the provided device comprises nozzle openings positioned along at least two lines extending from and transverse to the nozzle openings partly surrounding the support beam and in step C the nozzle openings along said lines create continuous cuts extending from and transverse to the continuous cut created by the nozzle openings partly surrounding the support beam in order to connect the continuous cut created by the nozzle openings partly surrounding the support beam with the partly cut created by the different cutting technique.

In an embodiment of the method according to the invention, in the provided device, said at least two lines extend in the same direction from the nozzle openings partly surrounding the support beam.

In an embodiment of the method according to the invention, step B is performed after the support beam is partly cut with the different cutting technique.

In an embodiment of the method according to the invention, step B is performed before the support beam is partly cut with the different cutting technique.

In an embodiment of the method according to the invention, step C is performed to complete the cut when the cutting of the support beam with the different cutting technique has failed and resulted in a partly cut.

In an embodiment of the method according to the invention, the device is used to finish the partly cut created with the different cutting technique.

In an embodiment of the method according to the invention, step B is performed under water by a remotely operated vehicle (ROV) or a human diver.

In an embodiment of the method according to the invention, the igniter is controlled by a switch and in step C the switch is located under water and activated.

In an alternative situation, part or all of the devices are attached to the support beams at a location above the water surface.

In an embodiment of the method according to the invention, in the steps D and E, a top side supported by the support structure and located above the water surface, is lifted and removed.

In an embodiment of the method according to the invention;

in the circular configuration of the device;

a first part of the nozzle openings is positioned in a first circular configuration in which the nozzle openings of the first part are directed to a first centre of the first circular configuration,

a second part of the nozzle openings is positioned in a second circular configuration in which the nozzle openings of the second part are directed to a second centre of the second circular configuration, wherein the nozzle openings of the second circular configuration are located at a distance from the nozzle openings of the first circular configuration, and

a third part of the nozzle openings is positioned in multiple intermediate configurations in which the nozzle openings of each intermediate configuration are positioned between the nozzle openings of the first part and the second part and are directed to a line extending through the first centre and second centre, and

the method comprises cutting the cylindrical support beam with a first circular cut created by the nozzle openings in the first circular configuration, a second circular cut located at a distance from the first circular cut and created by the nozzle openings in the second circular configuration, and multiple intermediate cuts created by the nozzle openings in the intermediate configuration, which intermediate cuts extend between the first circular cut and the second circular cut.

In an embodiment of the method according to the invention, the method comprises creating the first circular cut and the second circular cut parallel towards each other.

In an embodiment of the method according to the invention, the method comprises creating the first circular cut and the second circular cut, both extending perpendicular to a longitudinal axis of the cylindrical support beam on which the device is attached.

In an embodiment of the method according to the invention, the method comprises creating intermediate cuts which extend from the first circular cut until the second circular cut.

In an embodiment of the method according to the invention, the method comprises creating intermediate cuts which are positioned along a first intermediate line extending perpendicular to the first circular cut and the second circular cut.

In an embodiment of the method according to the invention, the method comprises creating intermediate cuts which are positioned along a second intermediate line extending transverse to the first circular cut and the second circular cut.

In an embodiment of the method according to the invention, the method comprises creating intermediate cuts which form a zigzag configuration extending between the first circular cut and the second circular cut.

In an embodiment of the method according to the invention, in step C the fuel material of the molten metal jet cutting units undergo self-contained and self-sustained exothermic chemical reactions to jet molten metal out of the nozzle openings.

In an embodiment of the method according to the invention, the cutting process in step C is non-explosive.

In an embodiment of the method according to the invention, the in step A provided device complies to any of the claims 34-67.

The invention furthermore relates a device for cutting a cylindrical support beam which forms part of a support structure of a sea platform under water, which device comprises;

a plurality of molten metal jet cutting units to cut the cylindrical support beam, wherein each of the molten metal jet cutting units comprises a housing surrounding a fuel chamber filled with a fuel material, and a duct connecting the fuel chamber with a nozzle opening, and

a cutting unit holder holding the plurality of molten metal jet cutting units to position the molten metal jet cutting units in a circular configuration in which the nozzle openings are directed to a centre of the circular configuration,

a fastener to attach the molten metal jet cutting units in the circular configuration to the cylindrical support beam with the nozzle openings of the molten metal jet cutting units directed to and at least partly surrounding the cylindrical support beam, and

an igniter operatively connected to the molten metal jet cutting units to ignite the fuel material so that molten metal is jetted out of the nozzle openings.

In an embodiment of the device according to the invention, the nozzle openings of the molten metal jet cutting units are, in the circular configuration, positioned to create a continuous cut around at least part of the cylindrical support beam.

In an embodiment of the device according to the invention, the cutting unit holder comprises multiple holder elements which are interconnected and pivotable relative to each other, and each holder element holds at least one molten metal jet cutting unit.

In an embodiment of the device according to the invention, the cutting unit holder comprises two and only two holder elements.

In an embodiment of the device according to the invention, the cutting unit holder comprises three and only three holder elements.

In an embodiment of the device according to the invention, the holder elements have the same dimensions.

In an embodiment of the device according to the invention, neighbouring holder elements are interconnected via a hinge.

In an embodiment of the device according to the invention, nozzle openings of the molten metal jet cutting units are , in the circular configuration, positioned to fully surround the support beam.

In an embodiment of the device according to the invention nozzle openings of the molten metal jet cutting units are, in the circular configuration, positioned to create a continuous cut around the entire cylindrical support beam.

In an embodiment of the device according to the invention nozzle openings of the molten metal jet cutting units are, in the circular configuration, positioned to partly surround the support beam.

In an embodiment of the device according to the invention, nozzle openings of the molten metal jet cutting units are, in the circular configuration, positioned to create a continuous cut around part of the cylindrical support beam.

In an embodiment of the device according to the invention, only part of the holder elements are holding at least one molten metal cutting jet unit.

In an embodiment of the device according to the invention, the device comprises nozzle openings positioned along at least two lines extending from and transverse to the nozzle openings partly surrounding the support beam.

In an embodiment of the device according to the invention, said at least two lines extend in the same direction from the nozzle openings partly surrounding the support beam.

In an embodiment of the device according to the invention, in the circular configuration of the device;

a first part of the nozzle openings is positioned in a first circular configuration in which the nozzle openings of the first part are directed to a first centre of the first circular configuration,

a second part of the nozzle openings is positioned in a second circular configuration in which the nozzle openings of the second part are directed to a second centre of the second circular configuration, wherein the nozzle openings of the second circular configuration are located at a distance from the nozzle openings of the first circular configuration, and

a third part of the nozzle openings is positioned in multiple intermediate configurations in which the nozzle openings of each intermediate configuration are positioned between the nozzle openings of the first part and the second part and are directed to a line extending through the first centre and second centre.

In an embodiment of the device according to the invention, the cutting unit holder comprises a first holder part holding molten metal jet cutting units which comprise the nozzle openings of the first circular configuration, a second holding part holding molten metal jet cutting units which comprise the nozzle openings of the second circular configuration and located at a distance from the first holding part, and multiple intermediate holding parts holding molten metal jet cutting units which comprise the nozzle openings of the intermediate configurations and extending between the first holding part and second holding part.

In an embodiment of the device according to the invention, the first circular configuration and the second circular configuration extend parallel towards each other.

In an embodiment of the device according to the invention, at least part of the nozzle openings in the intermediate configuration are positioned along a first intermediate line extending perpendicular to the first circular configuration and the second circular configuration.

In an embodiment of the device according to the invention, at least part of the nozzle openings in the intermediate configuration are positioned along a second intermediate line extending transverse to the first circular configuration and the second circular configuration.

In an embodiment of the device according to the invention, at least part of the nozzle openings in the intermediate configuration form a zigzag configuration extending between the first circular configuration and the second circular configuration.

In an embodiment of the device according to the invention, the fastener comprises clamping units to clamp on the support pipe when the device is positioned in the circular configuration.

In an embodiment of the device according to the invention, each clamping unit comprises a protrusion which in the circular configuration is movable towards and away from the centre in a protruding position and retracted position, respectively, and each clamping unit is configured to continuously force the protrusion towards the protruding position.

In an embodiment of the device according to the invention, each clamping unit comprises a spring to continuously force the protrusion towards the protruding position.

In an embodiment of the device according to the invention, the device comprises an inner side which in the circular configuration is directed to the centre, and the protrusions are located at the inner side.

In an embodiment of the device according to the invention, the device comprises an inner side which in the circular configuration is directed to the centre and the clamping units comprise elastic elements located at the inner side of the device.

In an embodiment of the device according to the invention, the fastener comprises a locking unit to hold the device in the circular configuration.

In an embodiment of the device according to the invention, the fastener comprises a ratchet unit provided at each hinge to prevent the pivoting of neighbouring holder elements relative to each other when the device is positioned in the circular configuration.

In an embodiment of the device according to the invention, the ratchet unit only allows movement of the holder elements towards the circular configuration, and not away from it.

In an embodiment of the device according to the invention, the igniter comprises a switch which is manually activatable by a diver or a switch which is activatable by a ROV.

In an embodiment of the device according to the invention, the igniter is an electrical igniter or an incendiary fuse igniter.

In an embodiment of the device according to the invention, the fuel material is a solid metal material.

In an embodiment of the device according to the invention, the fuel material comprises thermite or pyronol.

In an embodiment of the device according to the invention, the fuel material of the molten metal jet cutting units undergo self-contained and self-sustained exothermic chemical reactions to jet molten metal out of the nozzle openings.

In an embodiment of the device according to the invention, the cutting process is non-explosive.

### BRIEF DESCRIPTION OF THE DRAWINGS

Embodiments of the method and device will be described by way of example only, with reference to the accompanying schematic drawings in which corresponding reference symbols indicate corresponding parts, and in which:

the FIGS. 1-6 schematically show a views of an embodiment of the method according to the invention,

the FIGS. 7-12 schematically show a views of a further embodiment of the method according to the invention,

FIG. 13 schematically shows a view in perspective of the device according to the invention as used in the methods of the FIGS. 1-6 and 7-12,

FIG. 14 schematically shows an enlarge view of ratchet units and part of a locking unit, both forming part of the fastener of the device of FIG. 13,

FIG. 15 schematically shows an enlarged view of a switch forming part of the igniter of the device of FIG. 13,

FIG. 16 schematically shows a view in perspective of the device of FIG. 13 in the circular configuration,

FIG. 17 schematically shows a view in cross section of the device of FIG. 13,

FIG. 18 schematically shows a view in perspective of the device of FIG. 13 attached to one of the support beams of the support structure of FIG. 1,

FIG. 19 schematically shows a view in cross section of the device of FIG. 18,

FIG. 20 schematically shows a view in cross section of a further embodiment of the device of FIG. 19,

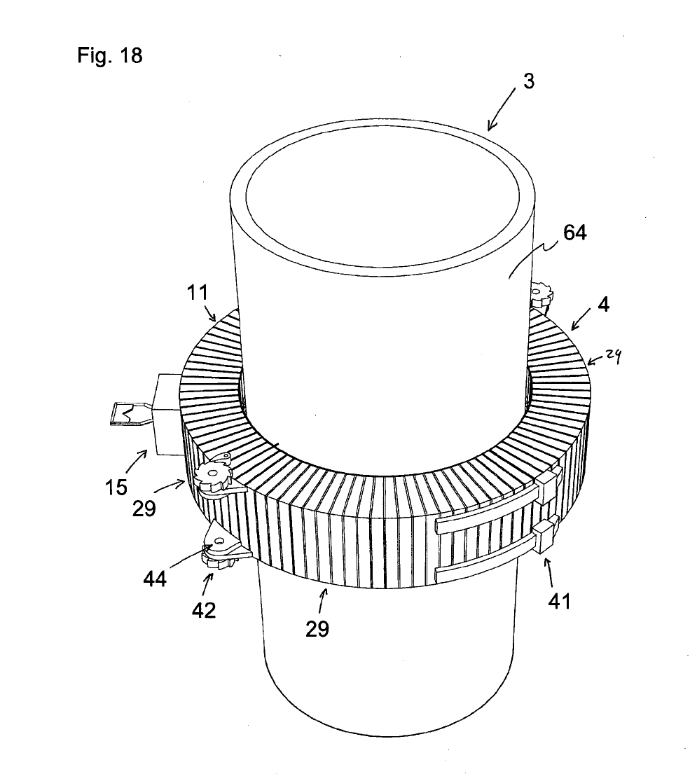

the FIGS. 21 and 22 schematically show a continuous cut created in the support beam by the device of FIG. 18,

the FIGS. 23-25 schematically show a further embodiment of the device according to the invention,

the FIGS. 26 and 27 schematically show a further embodiment of the device according to the invention,

the FIGS. 28-31 schematically show a further embodiment of the device according to the invention and the continuous cut created by said device,

the FIGS. 32-34 schematically show an alternative embodiment of the device of FIG. 28 and the continuous cut created by said device, and

the FIGS. 35-37 schematically show a further embodiment of the device and method according to the invention, wherein the support beam is partly cut by the molten metal cutting jet units and partly cut by a different cutting technique.

FIG. 1 shows a sea platform 1 comprising a support structure 2 with multiple cylindrical support beams 3. The support structure 2 is positioned on the seabed 30. The majority of the support beams 3 are located (partly or completely) under the water surface 20.

In FIG. 2, devices 4 for cutting a cylindrical support beam 3 are attached to several of the support beams 3 at a location under the water surface 20.

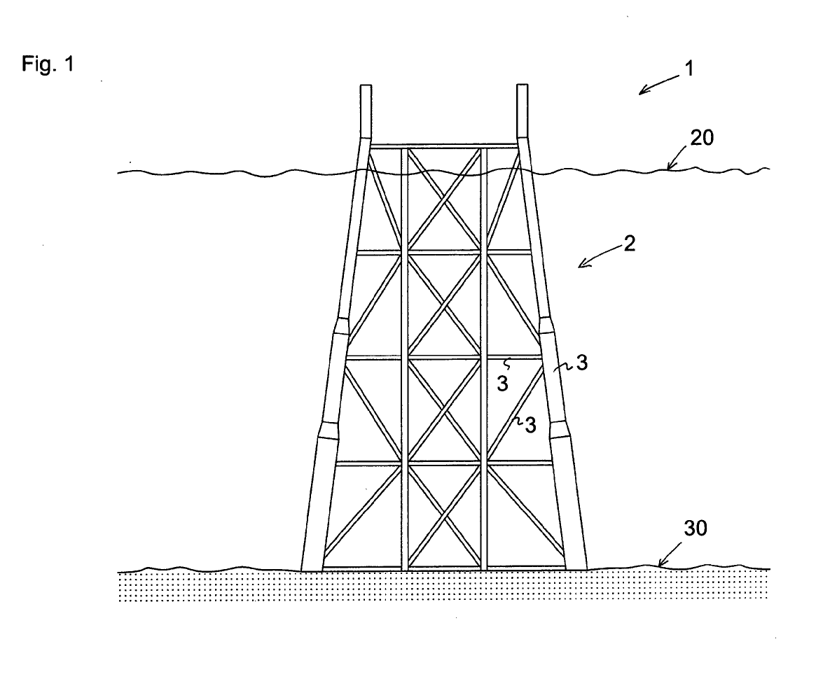

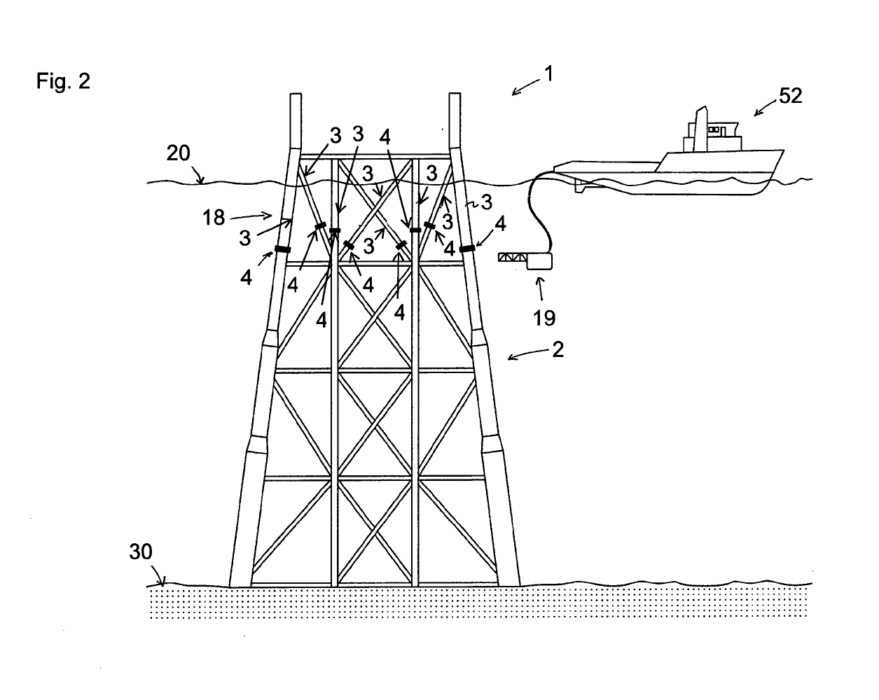

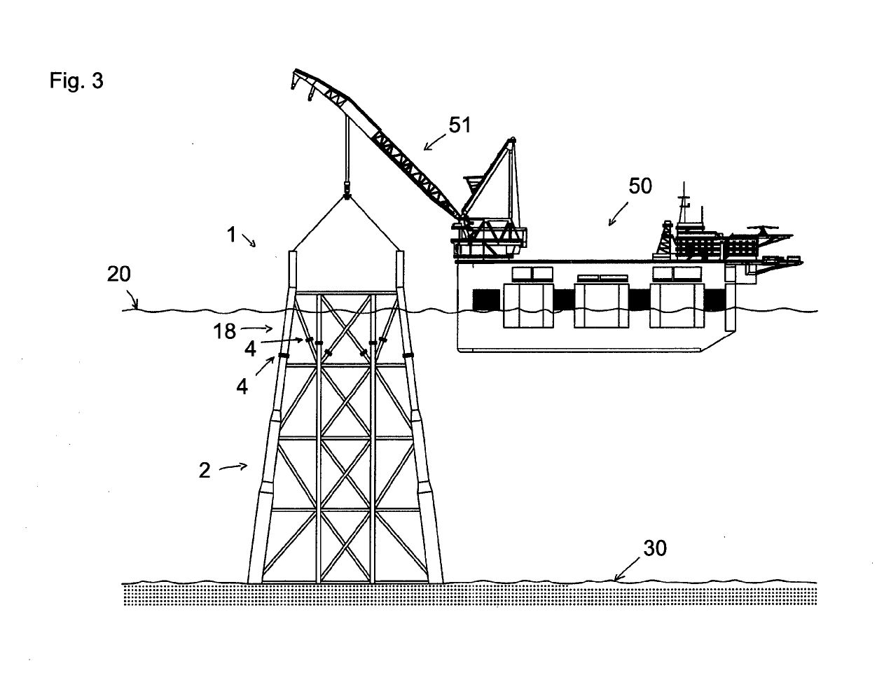

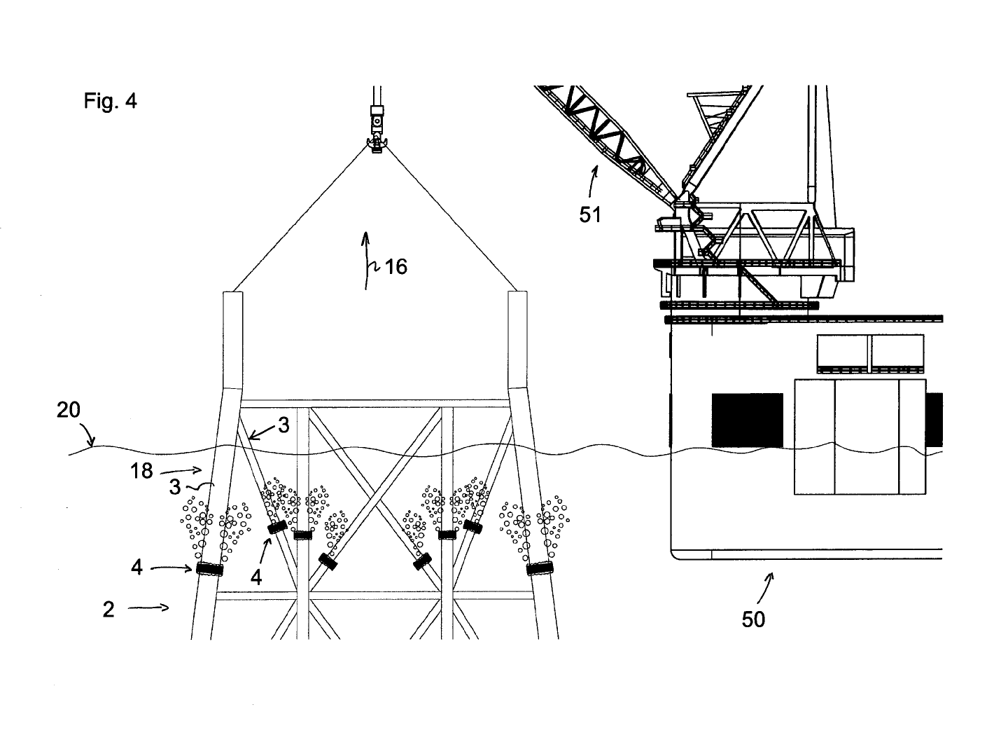

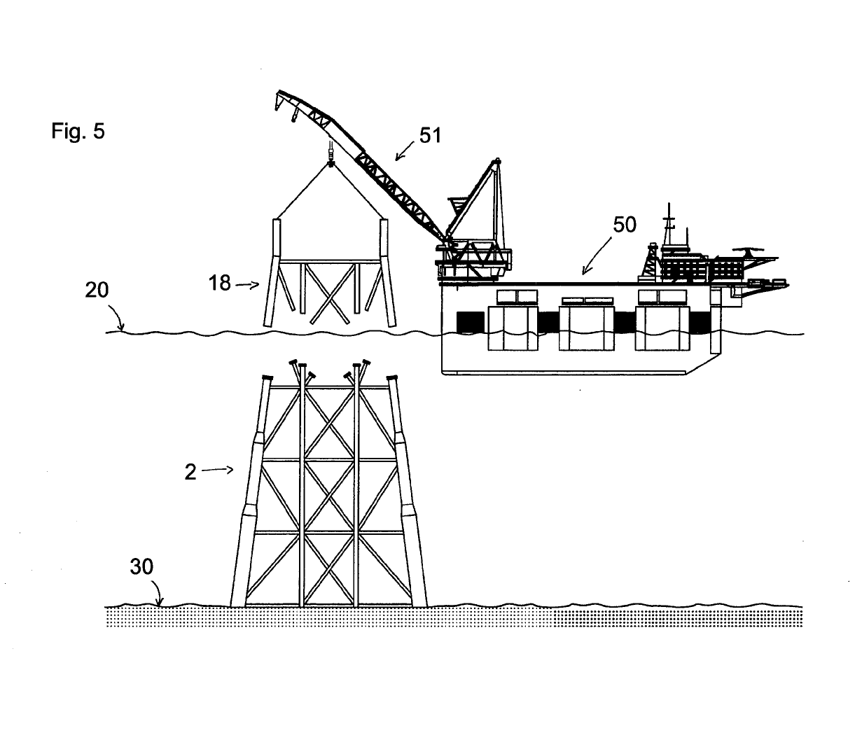

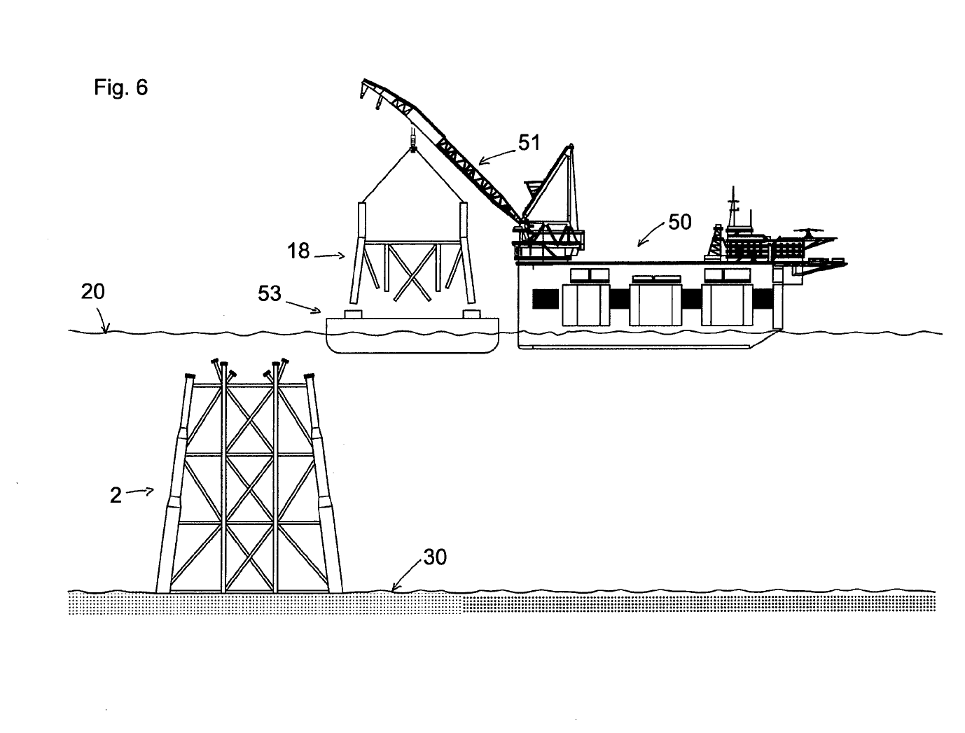

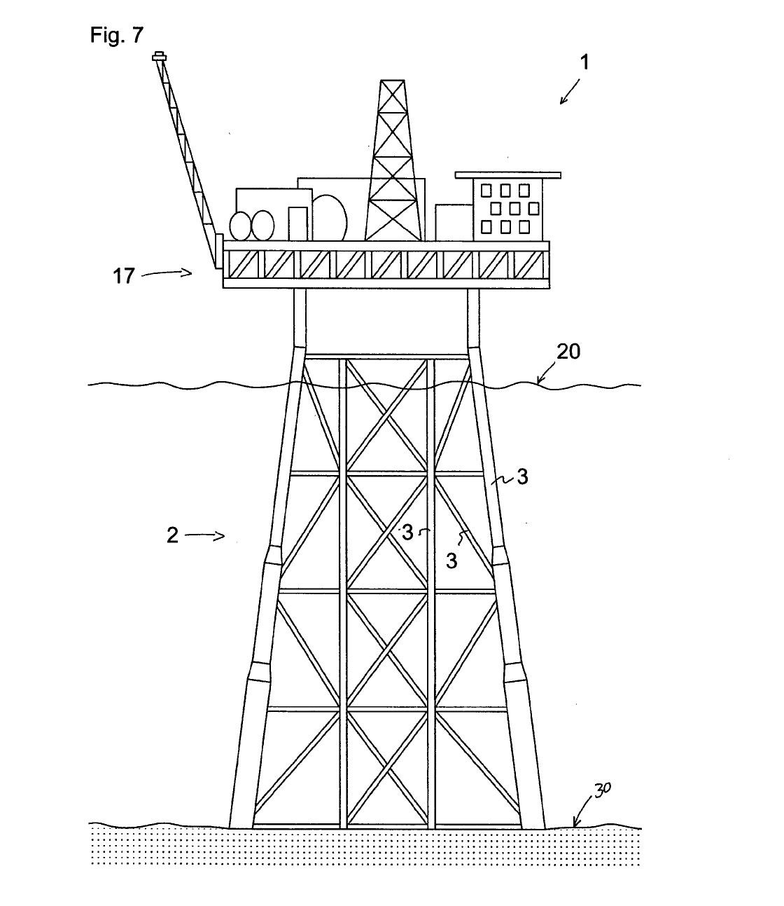

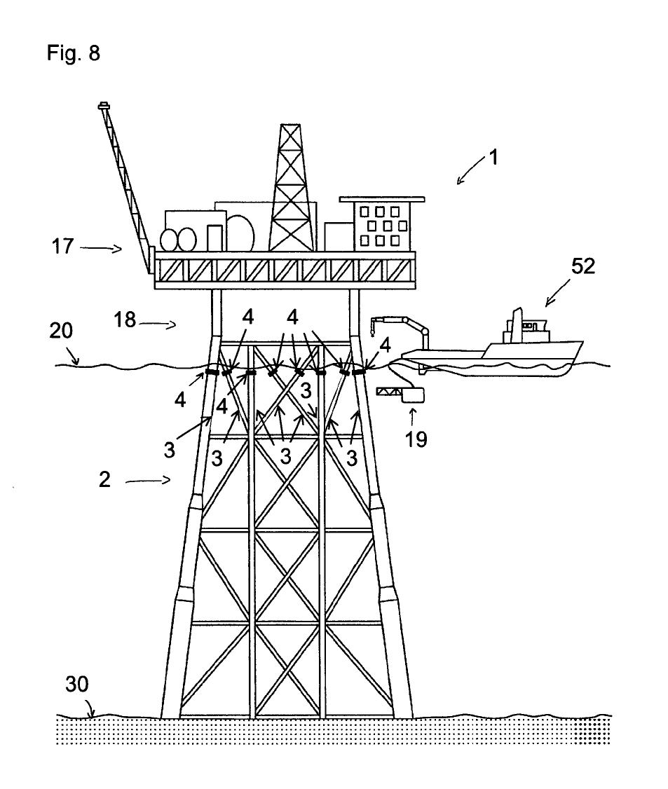

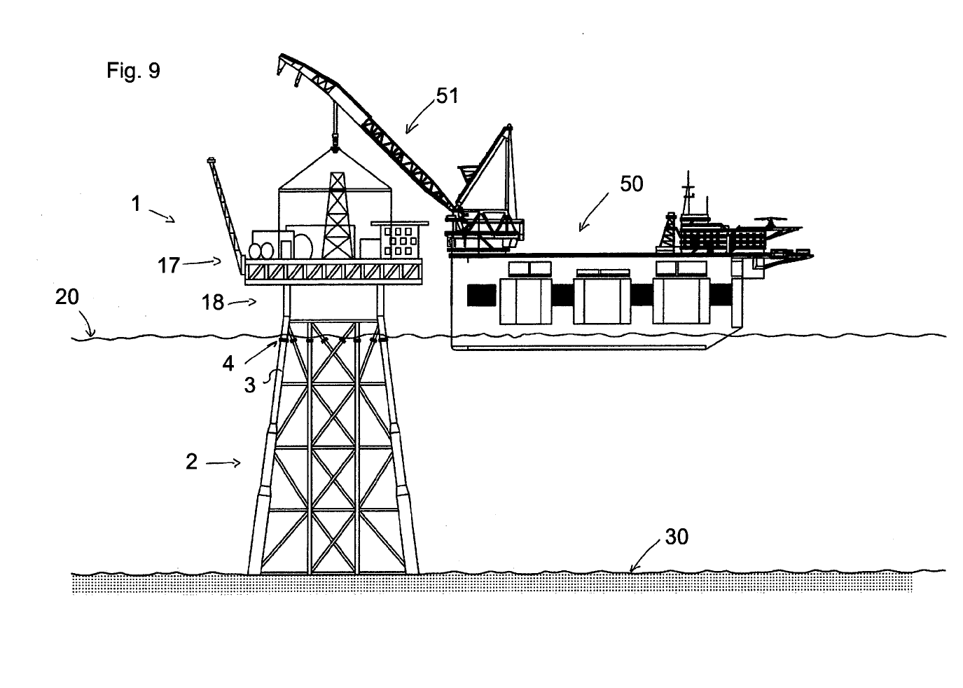

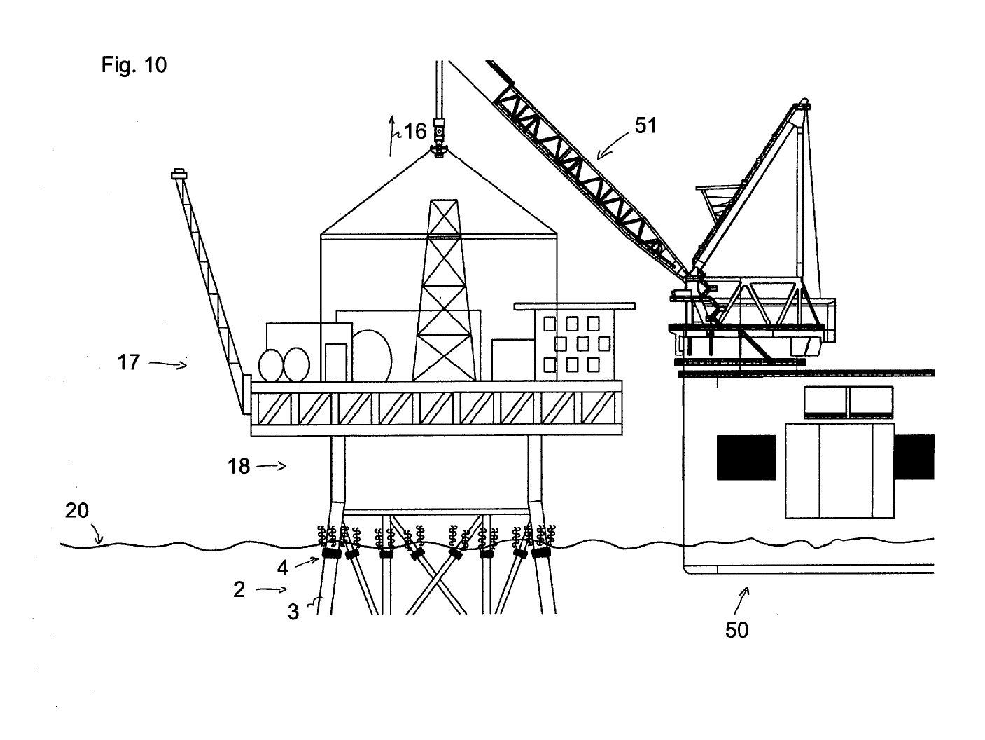

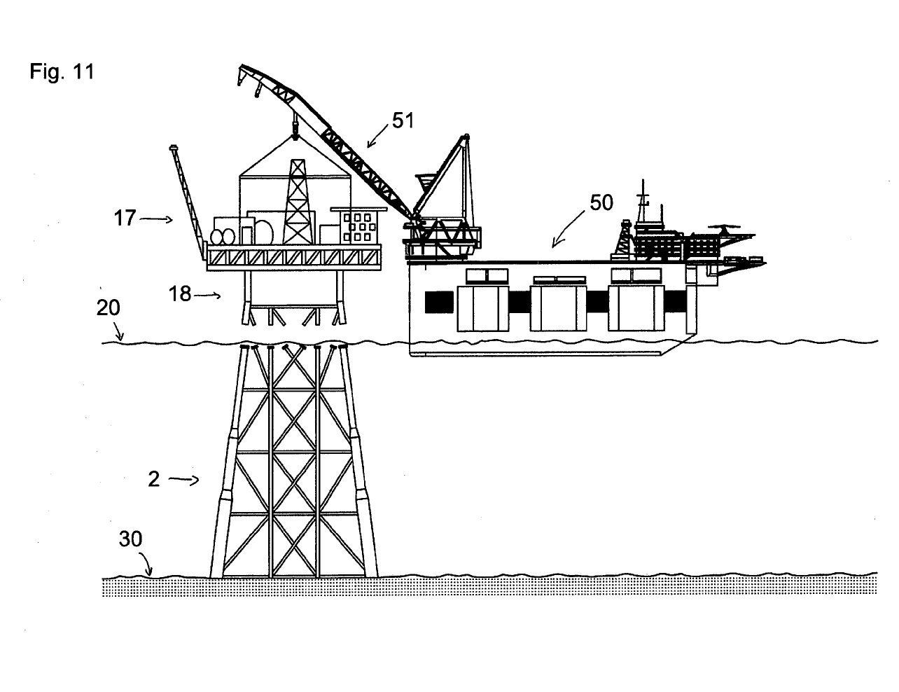

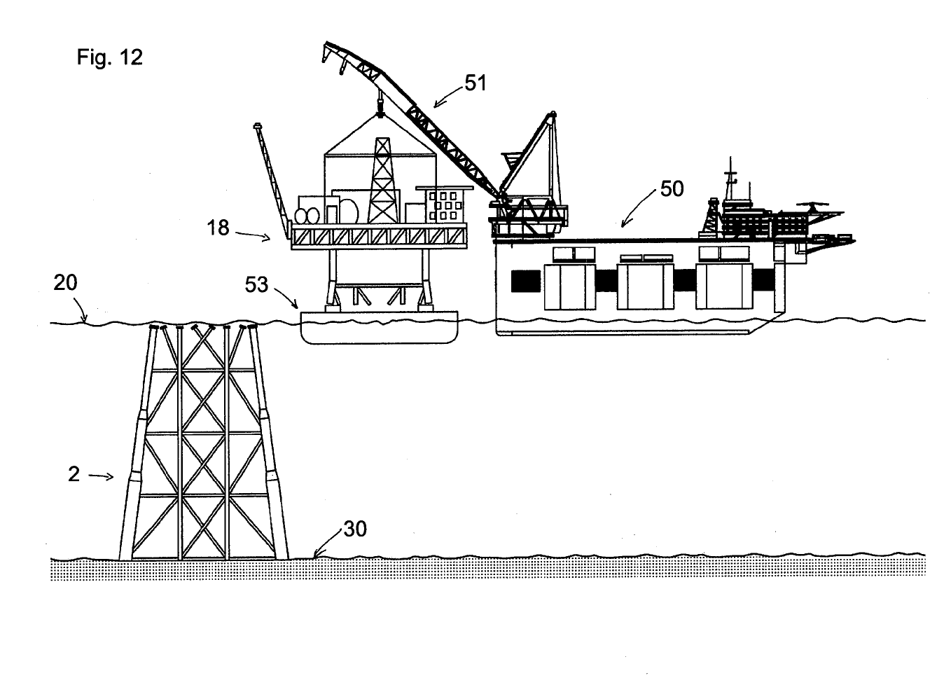

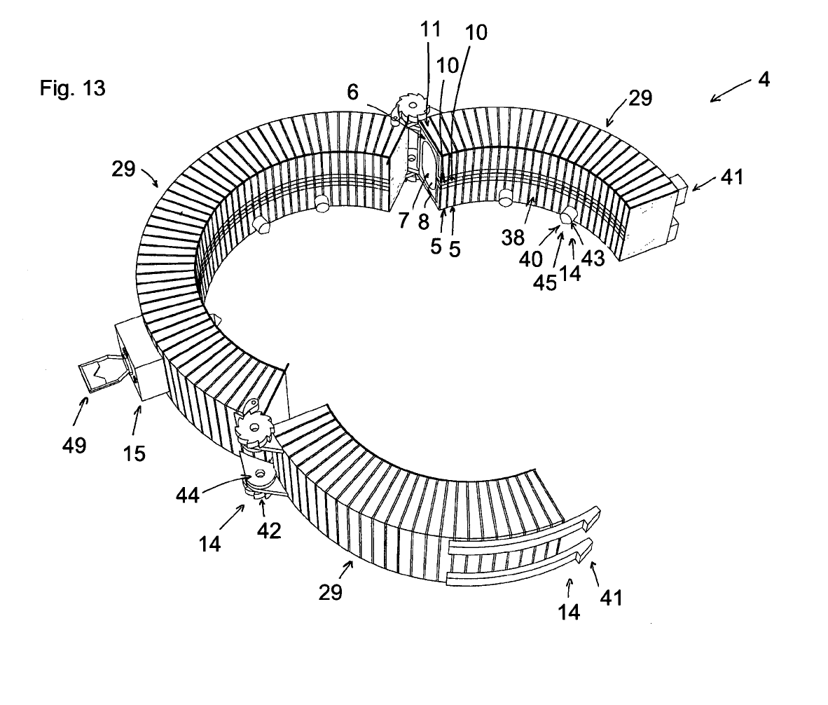

The device 4 comprises a plurality of molten metal jet cutting units 5 to cut the cylindrical support beam 3, wherein each of the molten metal jet cutting units 5 comprises a housing 6 surrounding a fuel chamber 7 filed with a fuel material 8, and a duct 9 connecting the fuel chamber 7 with a nozzle opening 10. The device 4 further comprises a cutting unit holder 11 holding the plurality of molten metal jet cutting units 5 to allow the positioning of the molten metal jet cutting units 5 in a circular configuration 12 in which the nozzle openings 10 are directed to a centre 13 of the circular configuration 12. The device 3 comprises a fastener 14 to attach the molten metal jet cutting units 5 in the circular configuration 12 to the cylindrical support beam 3, and an igniter 15 operatively connected to the molten metal jet cutting units 5 to ignite the fuel material 8 so that molten metal is jetted out of the nozzle openings 10. Embodiments of the device are amongst others shown in the FIGS. 13-18.

The devices 4 are attached under water to the support beams 3 in the circular configuration 12 via the fasteners 14. The nozzle openings 10 of the molten metal jet cutting units 5 are directed to and surround the cylindrical support beam 3.

The devices 4 are attached to the support beams 3 with the use of a remotely operated vehicle (ROV) 19. The ROV 19 is controlled from a support vessel 52 provided near the support structure 2. In other examples of the method, the devices 4 are attached to the support beams 3 by one or more human divers.

The devices 4 can be installed with the use of a support vessel 52. A removal vessel 50 is not required during the installation of the devices 4, although it is of course possible to perform this operation from a removal vessel 50. The costs for using a support vessel 52 is much lower when compared with a removal vessel 50.

In FIG. 3, a removal vessel 50 with a crane 51 is provided near the support structure 2. The crane 51 is connected to the part 18 of the sea platform 1 to be removed. In other examples of the method, the removal vessel 50 comprises at least one support arm which is placed under and in contact with at least part of the part of the sea platform 1 to be removed.

The removal vessel 50 carries at least part of the weight of the part of the sea platform 1 to be removed. In other examples of the method, the removal vessel 50 does not carry any significant part of the weight of the part of the sea platform 1 to be removed.

In FIG. 4, the fuel material 8 of the molten metal jet cutting units 5 is ignited to cut the surrounded cylindrical support beams 3 with molten metal which is jetted out of the nozzle openings 10 of the molten metal jet cutting units 5. When ignited, the fuel material 8 of the molten metal jet cutting units 5 undergo self-contained and self-sustained exothermic chemical reactions for the production of heat. The fuel material 8 is a solid metal material, which for example can comprise thermite or pyronol. During this pyrotechnic reaction, molten metal is jetted out of the nozzle openings 10 of the molten metal jet cutting units 5. This reaction is non-explosive. This means that no, or when compared to the use of explosives a significantly reduced, shockwave is produced after ignition.

In step C, each device 4 creates a continuous cut around the entire cylindrical support beam 3 it is attached to. This means that the part of the support beam 3 above the device 4 is cut loose from the part of the support beam 3 below the device 4. In other examples, the device 4 creates a continuous cut around part of the cylindrical support beam 3 it is attached to.

In the embodiment shown in the FIGS. 1-6, the steps A, B, and C are performed on multiple support beams 3 of the support structure 2 before the steps D and E are performed. Step C is performed simultaneously on the multiple support beams 3. In other embodiments of the method, step C is not performed simultaneously on the multiple support beams 3. The devices 3 can be ignited one after the other, or in several groups after each the other.

It is also possible that the devices 4 are used to cut part of the support beams 3 which need to be cut to disconnect the part of the sea platform 1 to be removed and that the rest of said support beams 3 are cut with a different cutting technique, such as with diamond wire cutting, water jet cutting, or shear cutting. The cutting with a different cutting technique can be performed after the cutting with the devices 4 in order to complete the disconnection of the part of the sea platform 1 to be removed. The cutting with a different cutting technique can be performed before the cutting with the devices 4, so that the cutting of the devices 4 will complete the disconnection of the part of the sea platform 1 to be removed.

The cutting with the devices 4 can also be used as a “back up” for when the cutting with a different technique, such as with diamond wire cutting, water jet cutting, or shear cutting, fails. In said method, the support beams 3 to which the devices 4 are attached have been partly cut with the different cutting technique before step C. Step B can be performed after the support beam 3 is partly cut with the different cutting technique or before the support beam 3 is partly cut with the different cutting technique. The device 4 is used to complete the cut when the cutting one or more of the support beams 3 with the different cutting technique fails.

In the embodiment shown in the FIGS. 1-6, the crane 51 remains attached to the part 18 of the sea platform 1 to be removed when the molten metal jetted of the molten metal jet cutting units 5 is cutting the support beams 3. The crane 51 applies an upward pulling force 16 on the part 18 of the sea platform 1 to be removed in order to carry at least part of the weight of the part of the sea platform 1 to be removed.

In FIG. 5, the crane 51 is lifting the disconnected part 18 of the sea platform 1 to be removed. The disconnected part 18 is lifted above the water surface 20.

In FIG. 6, the disconnected part 18 is placed on a transport vessel 53 to transport the disconnected part 18 to a different location. Alternative methods to transport the disconnected part 18 may for instance include transportation while suspended from the crane(s) or on the deck of the removal vessel 50.

The FIGS. 7-12 show a views of a further embodiment of the method according to the invention. The method steps shown in the FIGS. 7-12, correspond to the method steps shown in the FIGS. 1-6, respectively. The method of the FIGS. 7-12 differs from the one shown in the FIGS. 1-6, in that a top side 17 supported by the support structure 3 and located above the water surface 20 is lifted and removed in the steps D and E. The devices 4 are located in the splashing zone of the water.

FIG. 13 shows a view in perspective of the device 4 used in the methods of the FIGS. 1-6 and 7-12. The device 4 comprises a plurality of molten metal jet cutting units 5 to cut the cylindrical support beam 3, wherein each of the molten metal jet cutting units 5 comprises a housing 6 surrounding a fuel chamber 7 filled with a fuel material 8, and a duct 9 connecting the fuel chamber 7 with a nozzle opening 10. A cutting unit holder 11 holds the plurality of molten metal jet cutting units 5 to allow the positioning of the molten metal jet cutting units 5 in a circular configuration 12 in which the nozzle openings 10 are directed to a centre 13 of the circular configuration 12. A fastener 14 is provided to attach the molten metal jet cutting units 5 in the circular configuration 12 to the cylindrical support beam 3 with the nozzle openings 10 of the molten metal jet cutting units 5 directed to and surrounding 5 the cylindrical support beam 3. An igniter 15 is operatively connected to the molten metal jet cutting units 5 to ignite the fuel material 8 so that molten metal is jetted out of the nozzle openings 10 to cut the support beam 3.

The cutting unit holder 11 comprises multiple holder elements 29 which are interconnected and pivotable relative to each other, and each holder element 29 holds at least one molten metal jet cutting unit 5. More specifically, each holder element 29 hold multiple metal jet cutting units 5. Neighbouring holder elements 29 are interconnected via a hinge 44. The cutting unit holder 11 comprises three and only three holder elements 29. In other examples of the device 1, the cutting unit holder 11 comprises two and only two holder elements 29. In yet other examples of the device 1, the cutting unit holder 11 comprises a different number of holder elements 29.

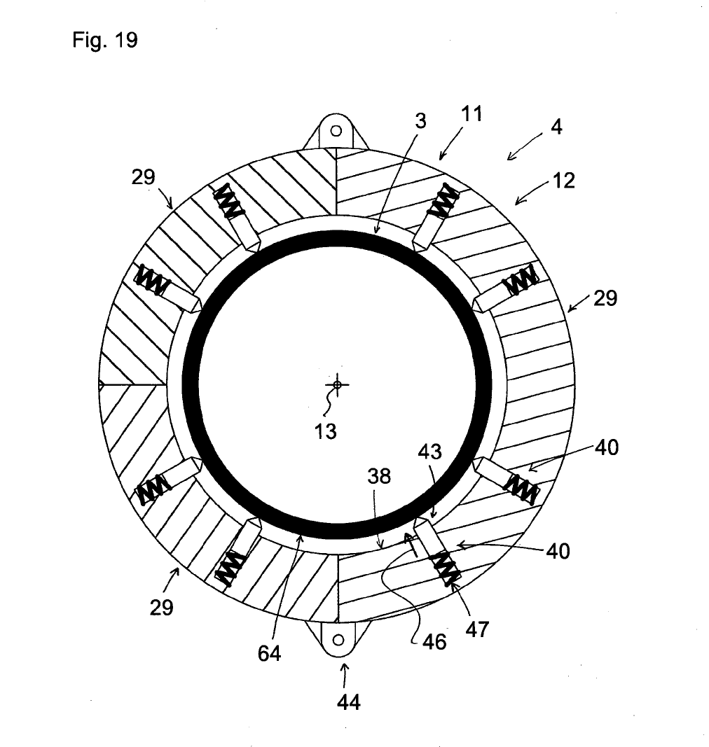

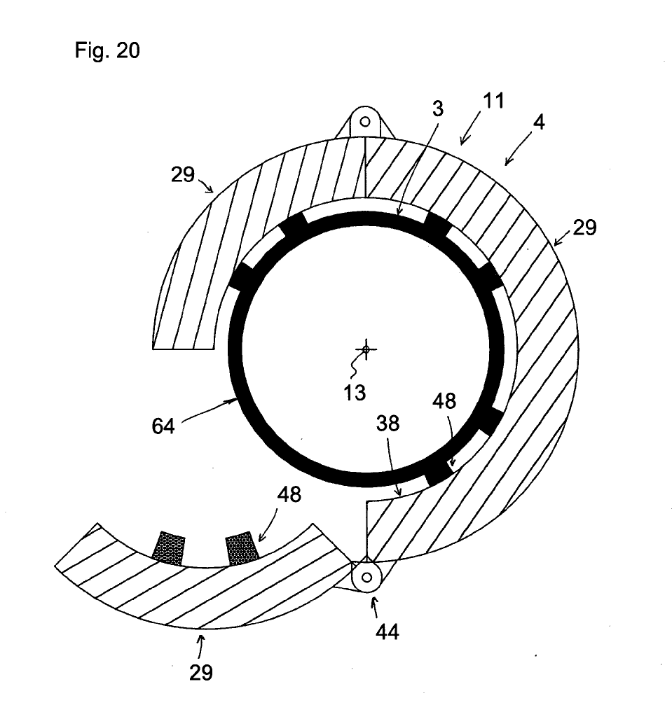

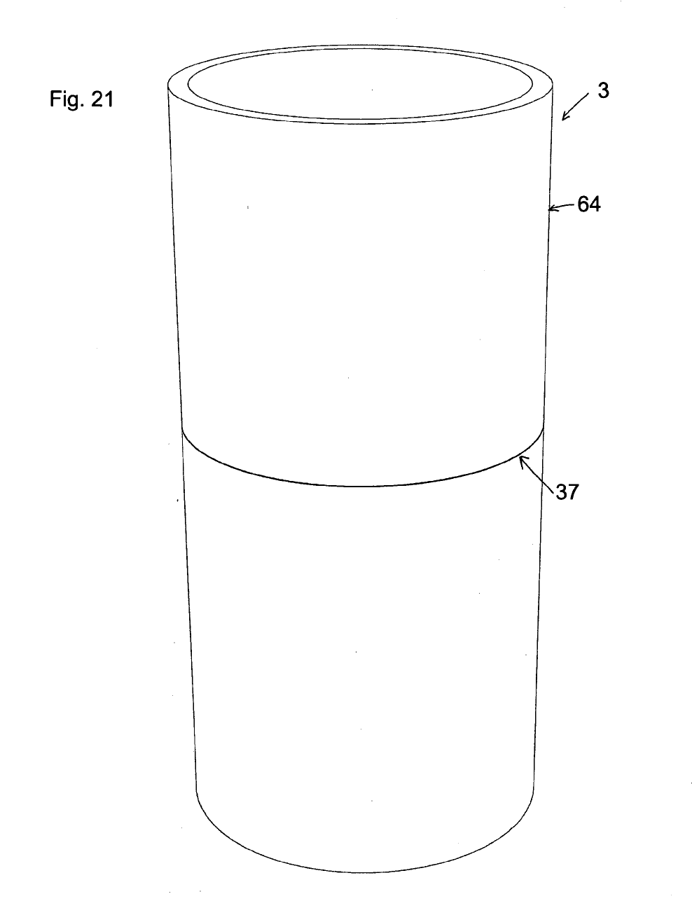

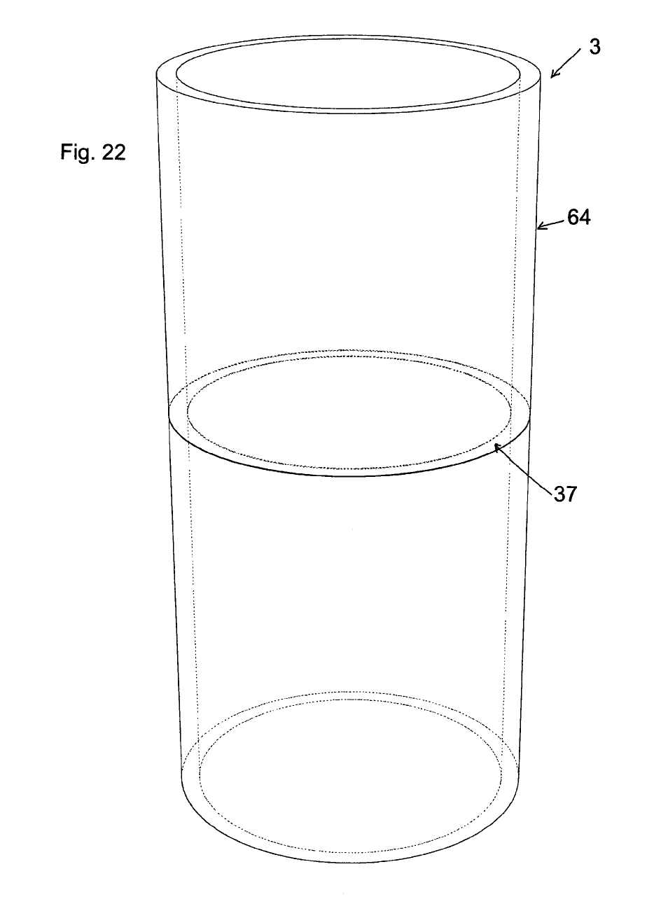

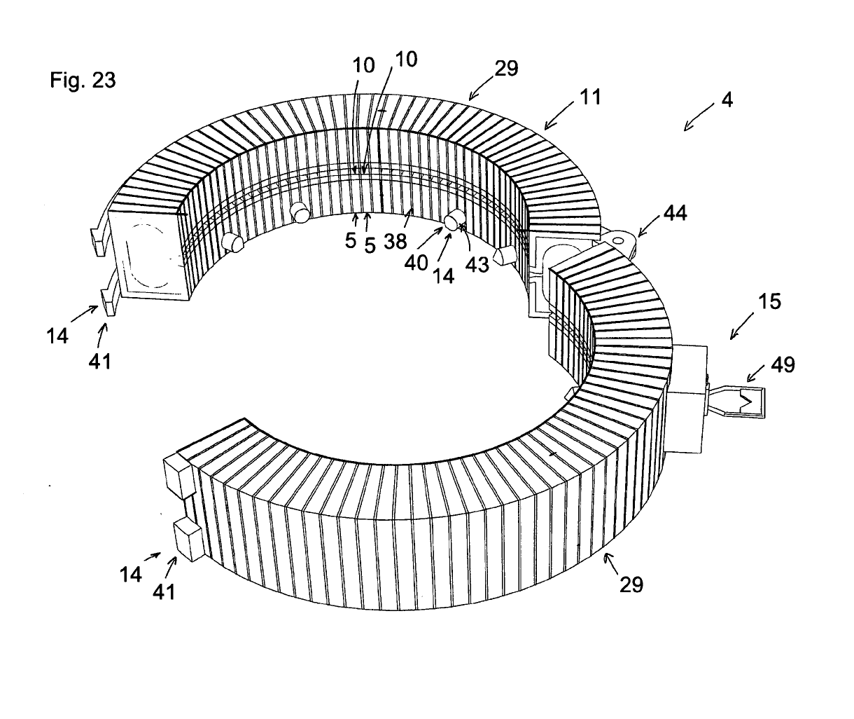

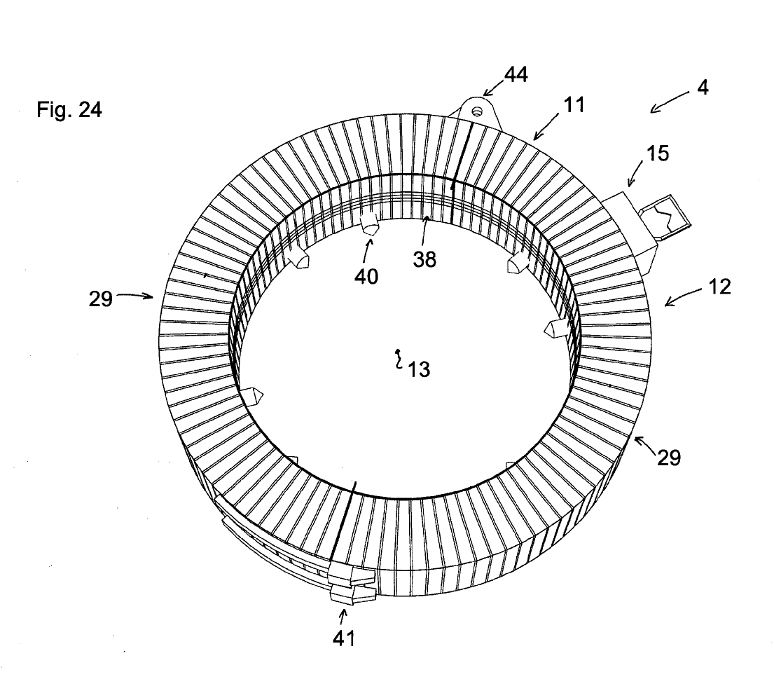

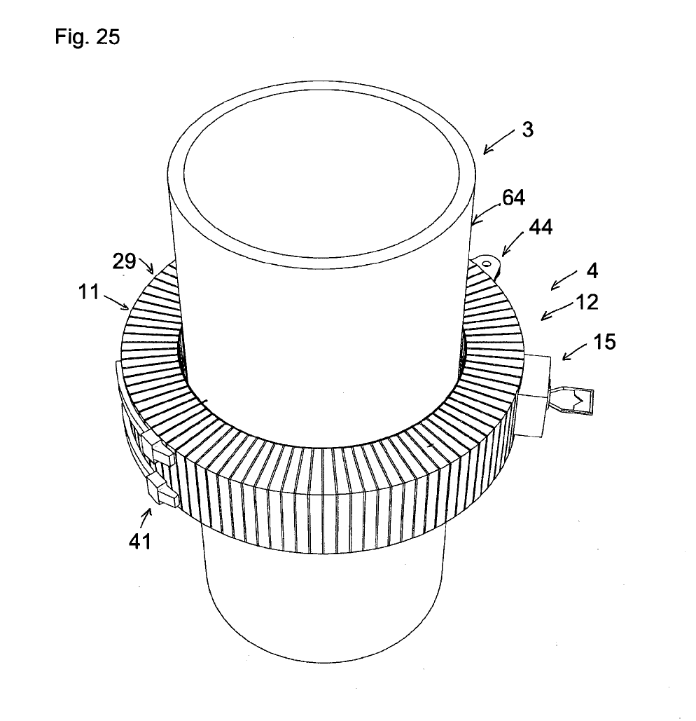

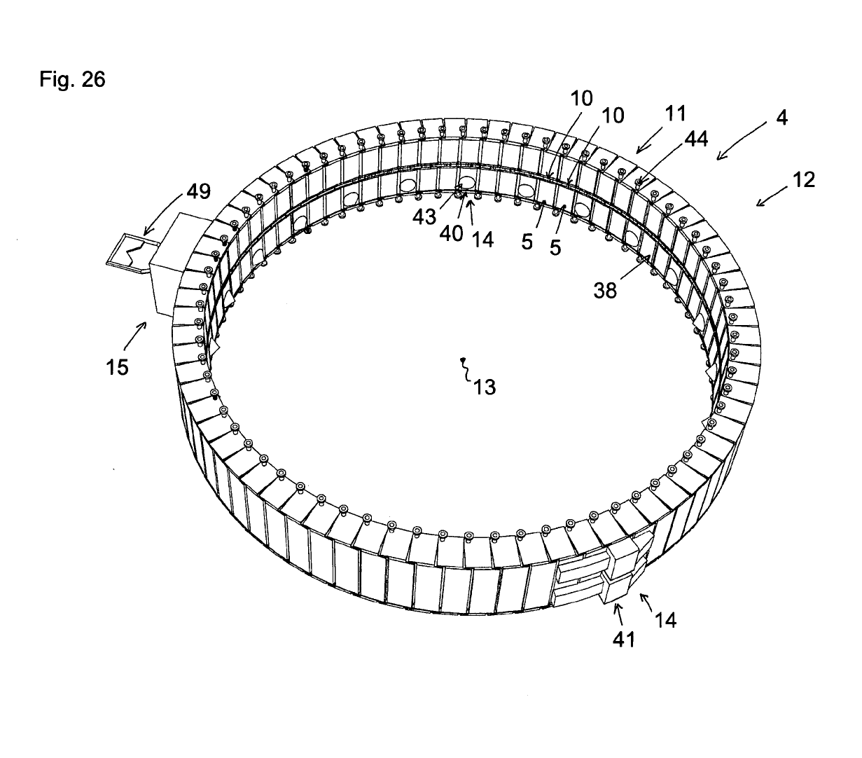

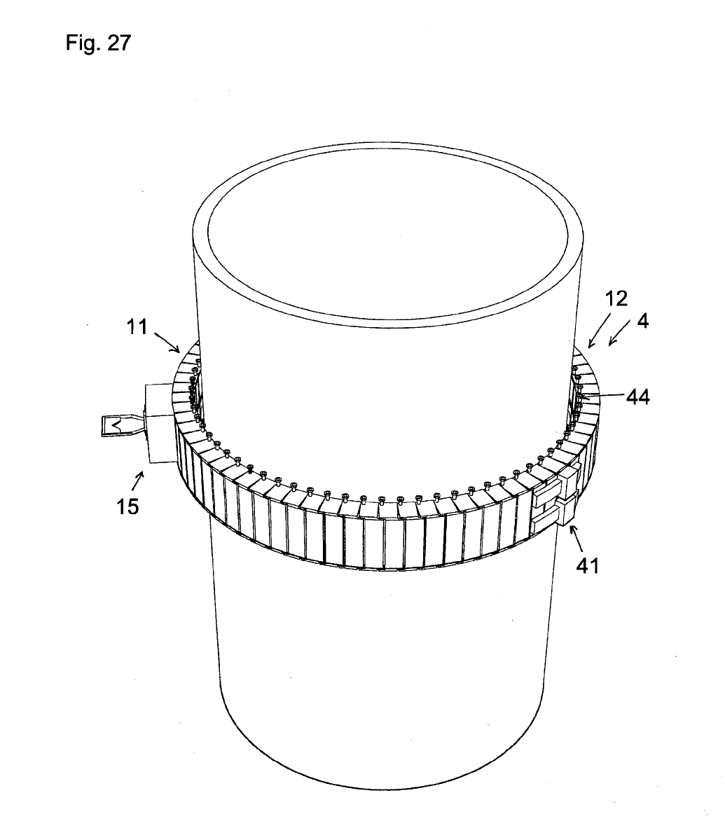

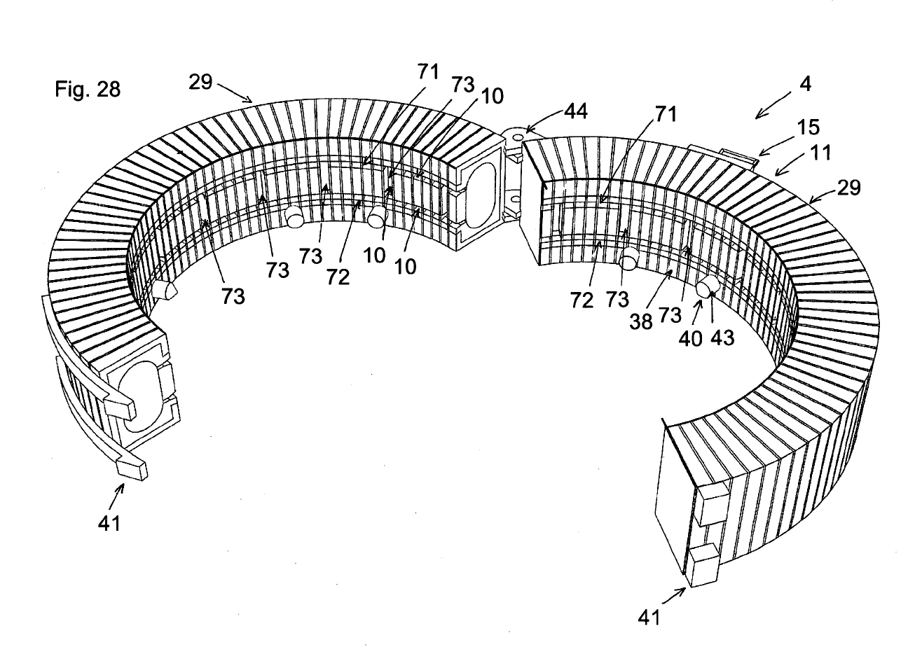

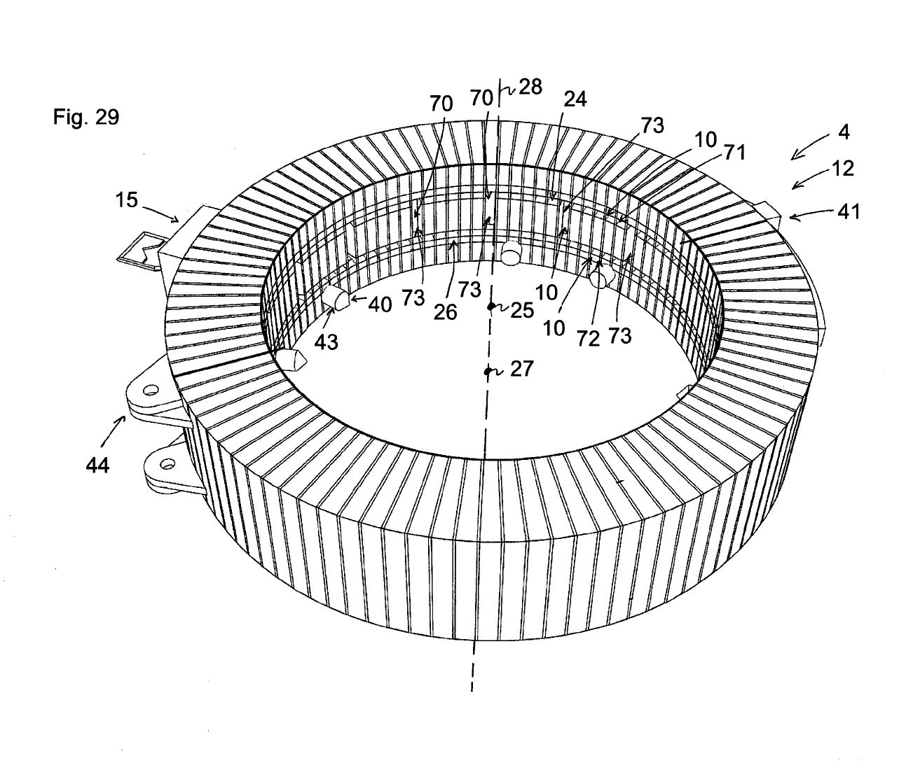

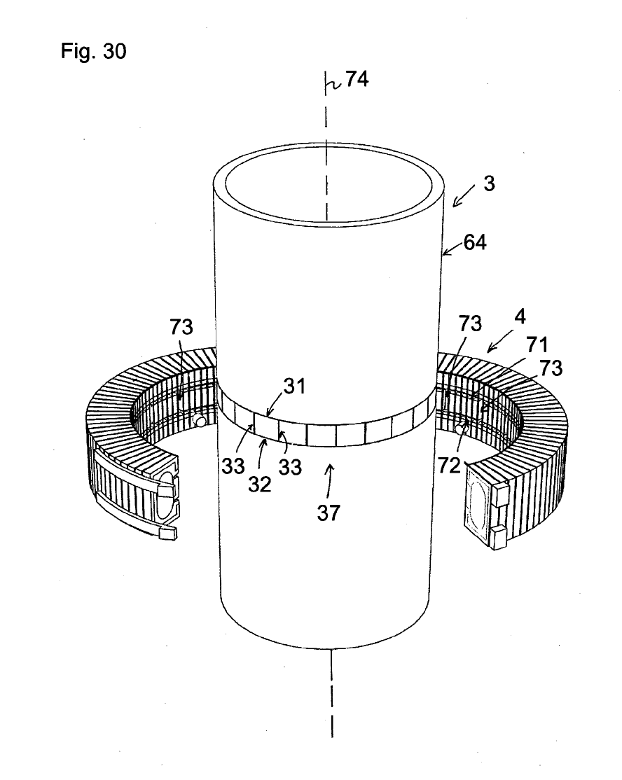

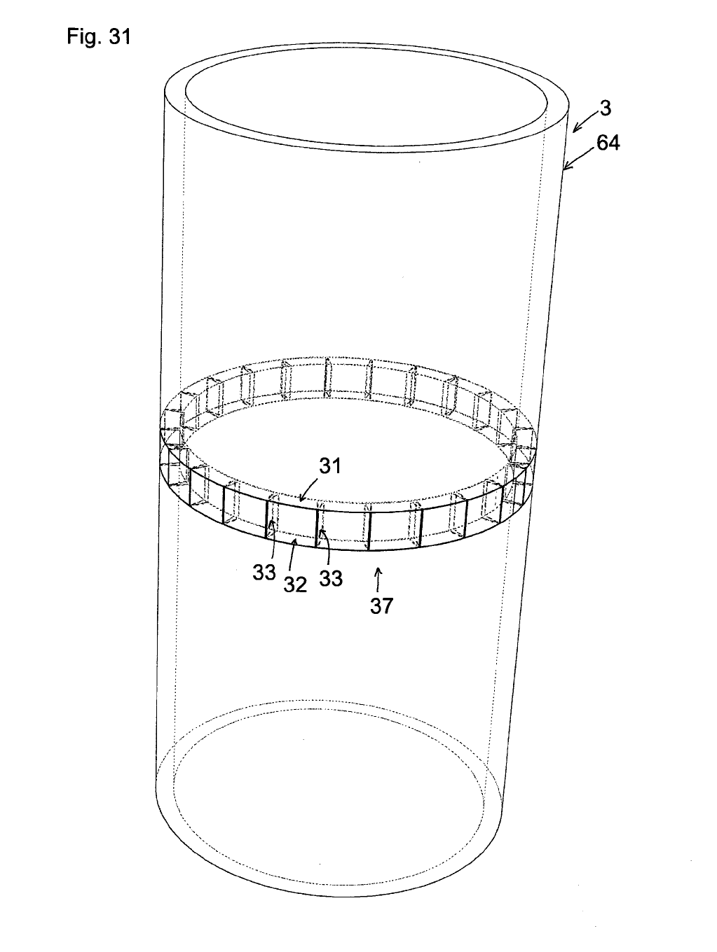

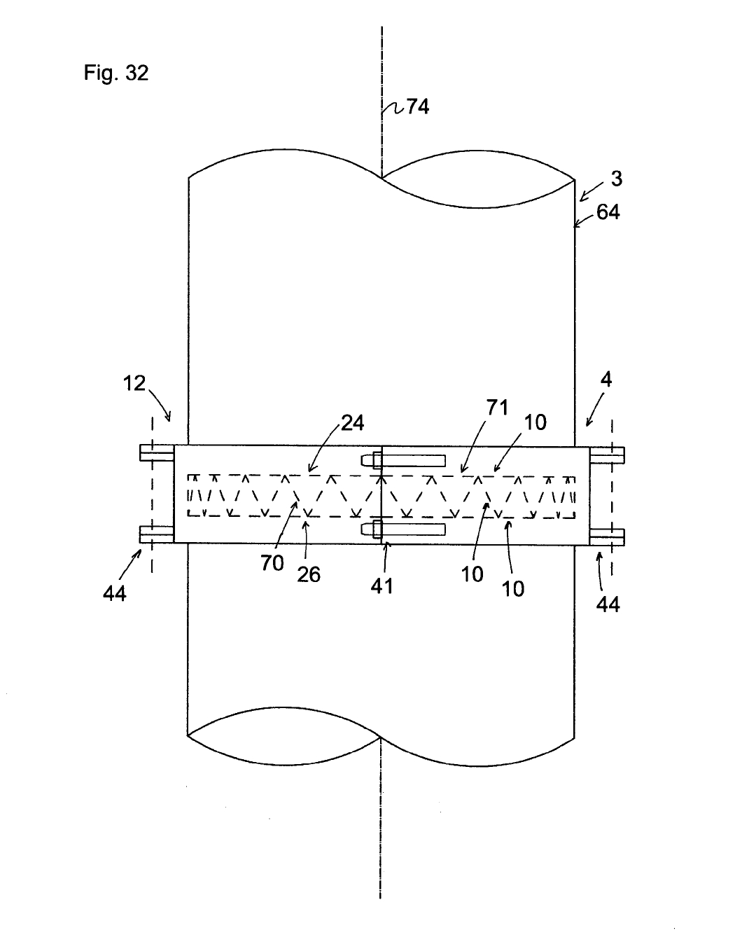

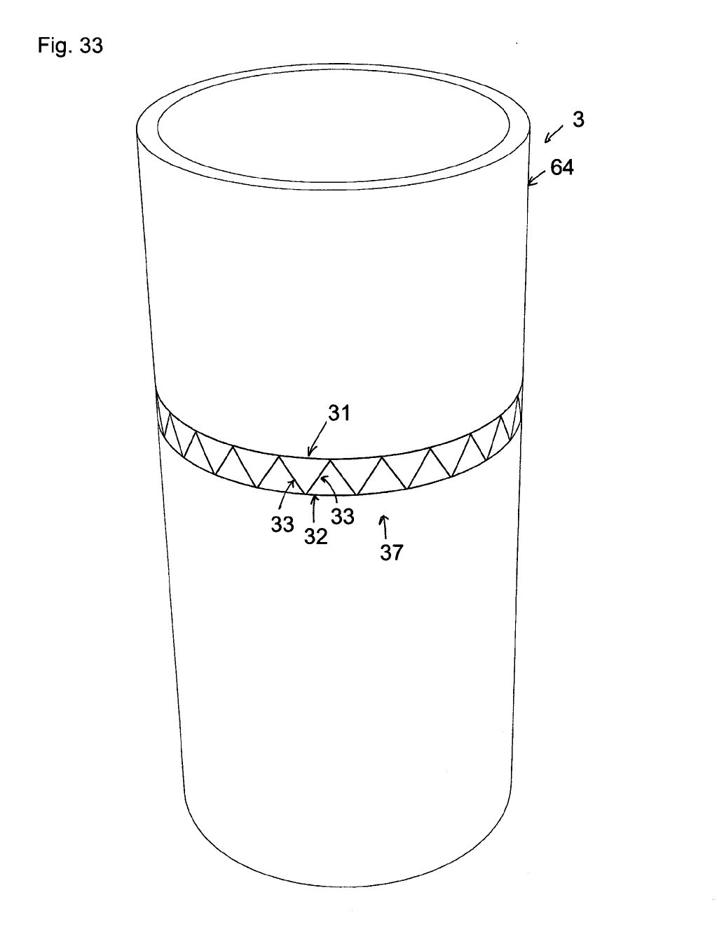

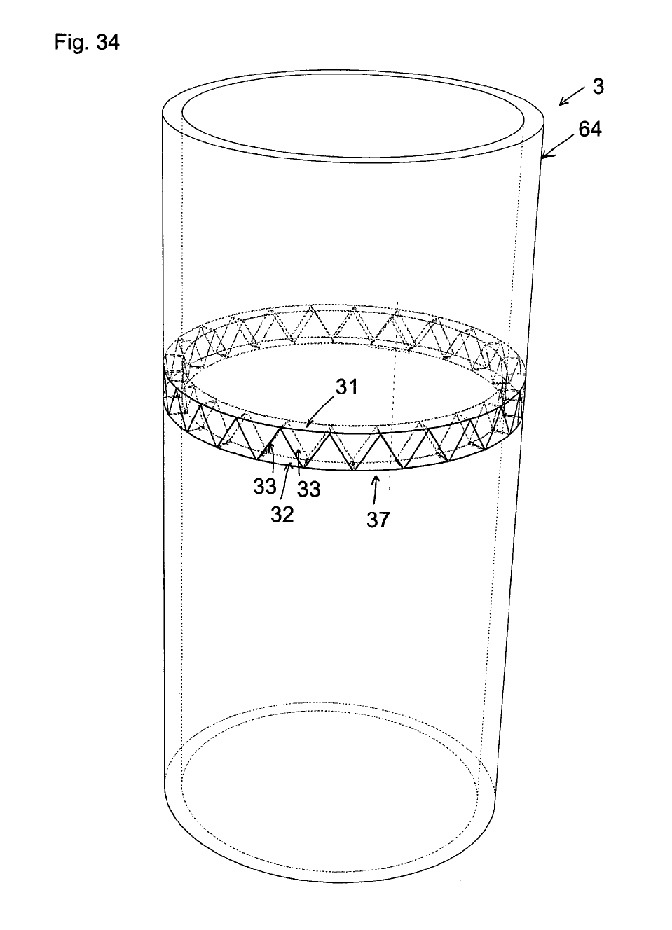

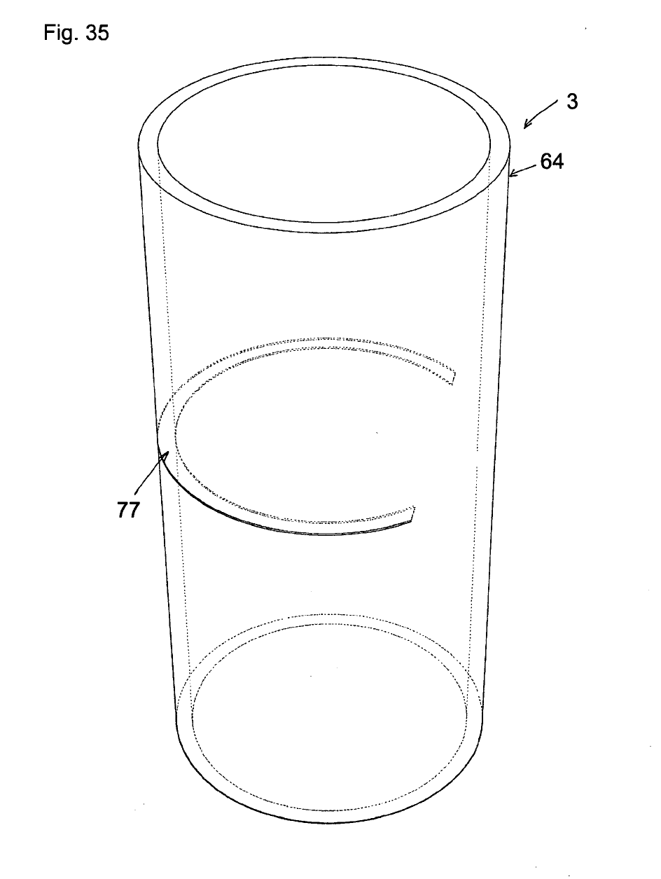

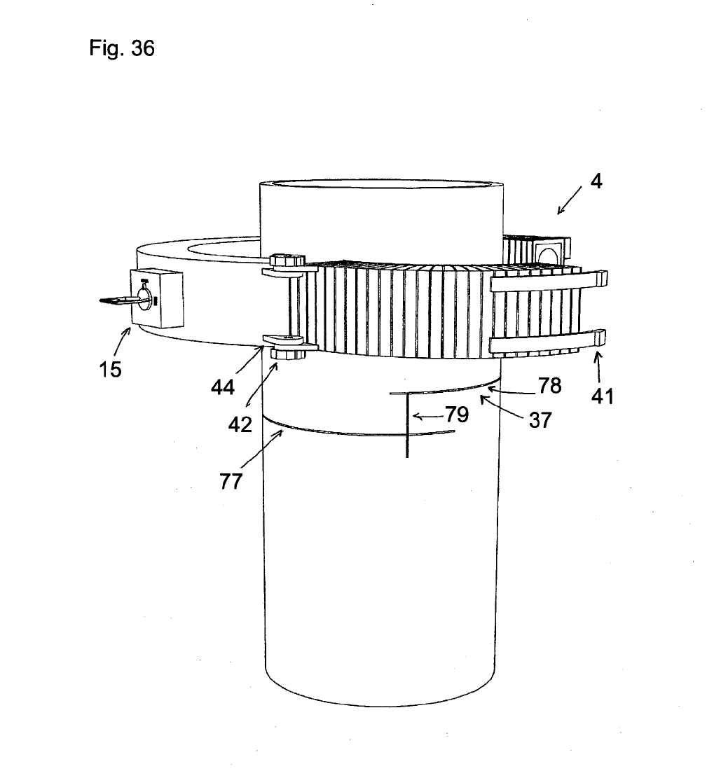

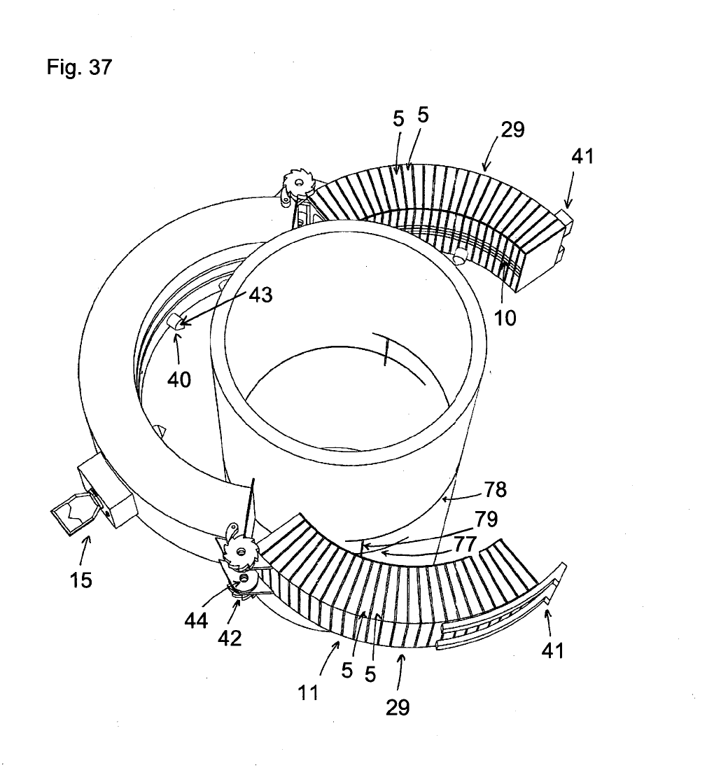

The fastener 14 comprises clamping units 40, wherein each clamping unit 40 comprises a protrusion 43 which in the circular configuration 12 is movable towards and away from the centre 13 in a protruding position 45 and retracted position, respectively, and each clamping unit 40 is configured to continuously force the protrusion 43 towards the protruding position 45. This allows the device 4 positioned in the circular configuration 12 to engage the support beam 3 in order to be attached to the support beam 4. This situation is shown in FIG. 19. Each clamping unit 40 comprises a spring 47 to continuously force the protrusion 43 towards the protruding position 45. The device 1 comprises an inner side 38 which in the circular configuration 12 is directed to the centre 13, and the protrusions 43 are located at the inner side 38. The direction in which the force of the springs 47 is applied is indicated by arrow 46. An alternative embodiment is shown in FIG. 20, wherein each clamping unit 40 comprises an elastic member 48 located at the inner side 38 of the device 4.

The fastener 14 comprises also a locking unit 41 to lock the device in the circular configuration 12.

The fastener 14 furthermore comprises ratchet units 42 provided at each hinge 44 to prevent the pivoting of neighbouring holder elements 29 relative to each other when the device 1 is positioned in the circular configuration 12. The ratchet units 42 only allow movement of the holder elements 29 towards the circular configuration 12, and not away 35 from it. An enlarged view of the ratchet unit 42 is shown in FIG. 14.

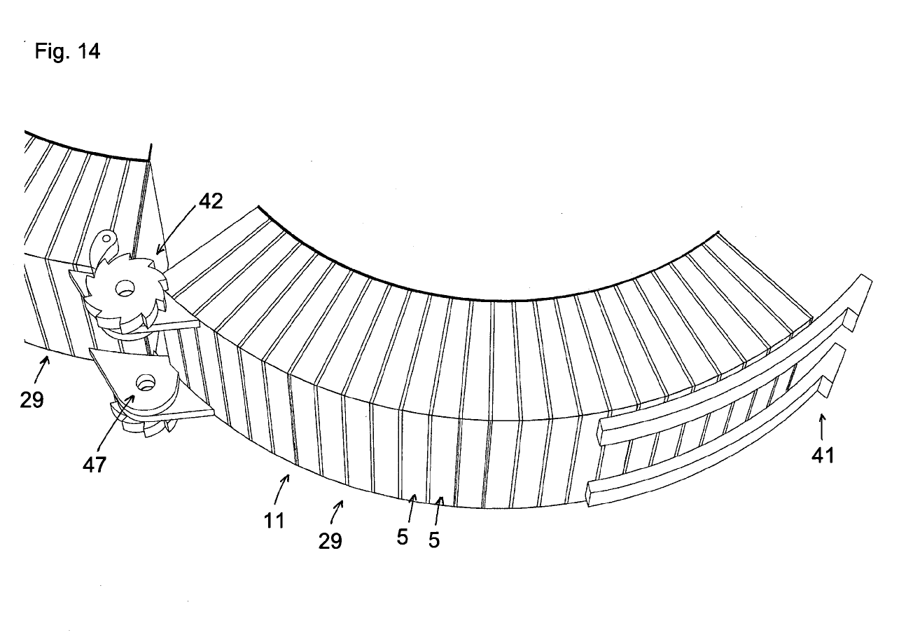

The igniter 15 comprises a switch 49 which is manually activatable by a diver or by a ROV. The igniter 15 is an electrical igniter. In other embodiments of the device, the igniter 15 is an incendiary fuse igniter. An enlarged view of the switch 49 of the igniter 15 is shown in FIG. 15.

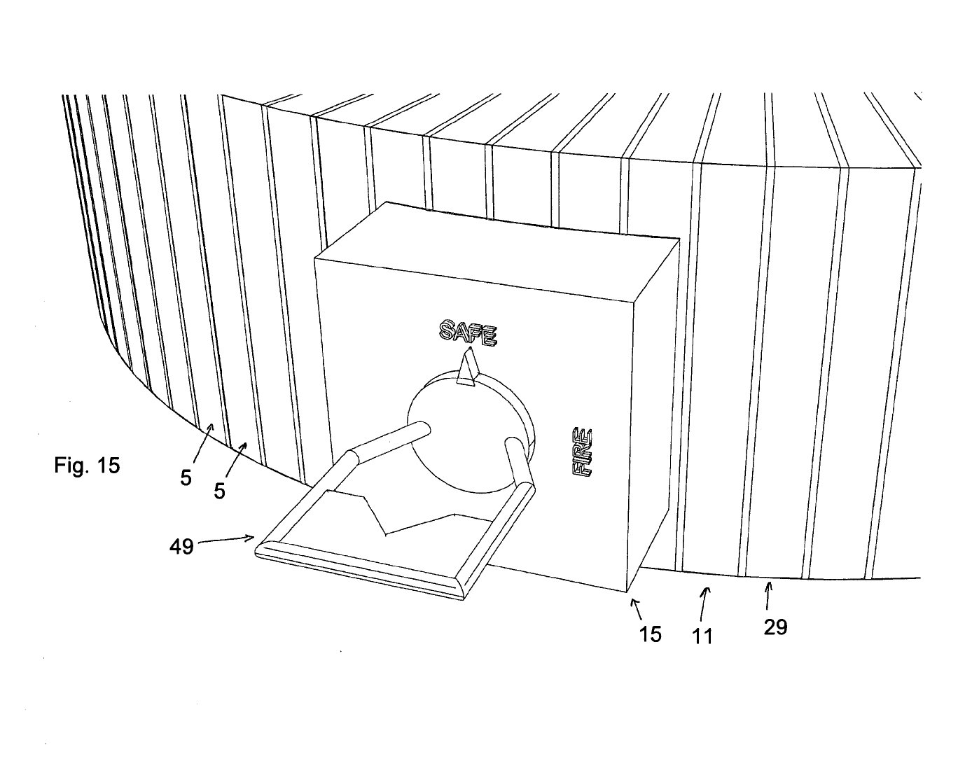

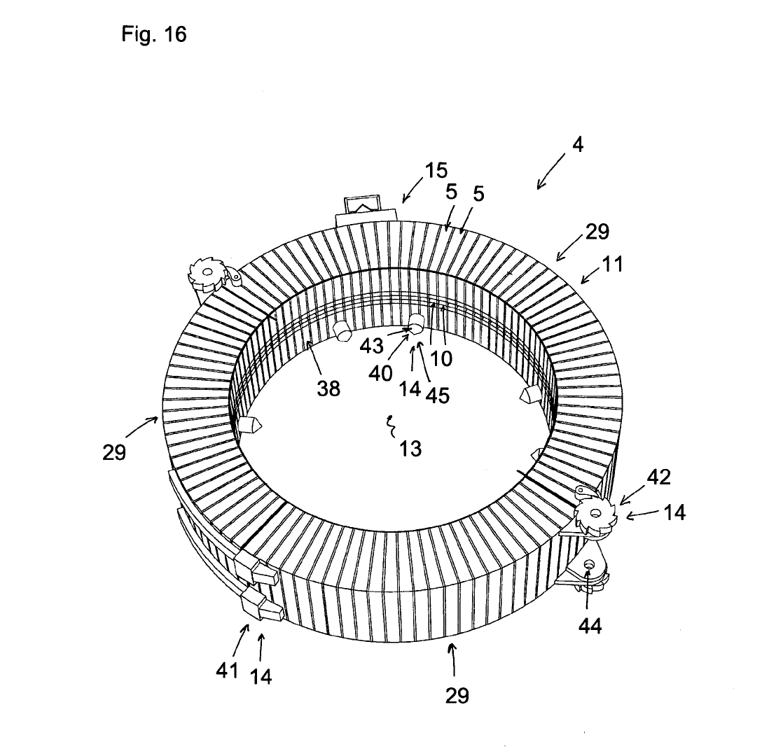

FIG. 16 shows the device of FIG. 13 in the circular configuration 12. In the circular configuration 12, the nozzle openings 10 of the molten metal jet cutting units 5 are positioned to create a continuous cut 37 around the cylindrical support beam 3.

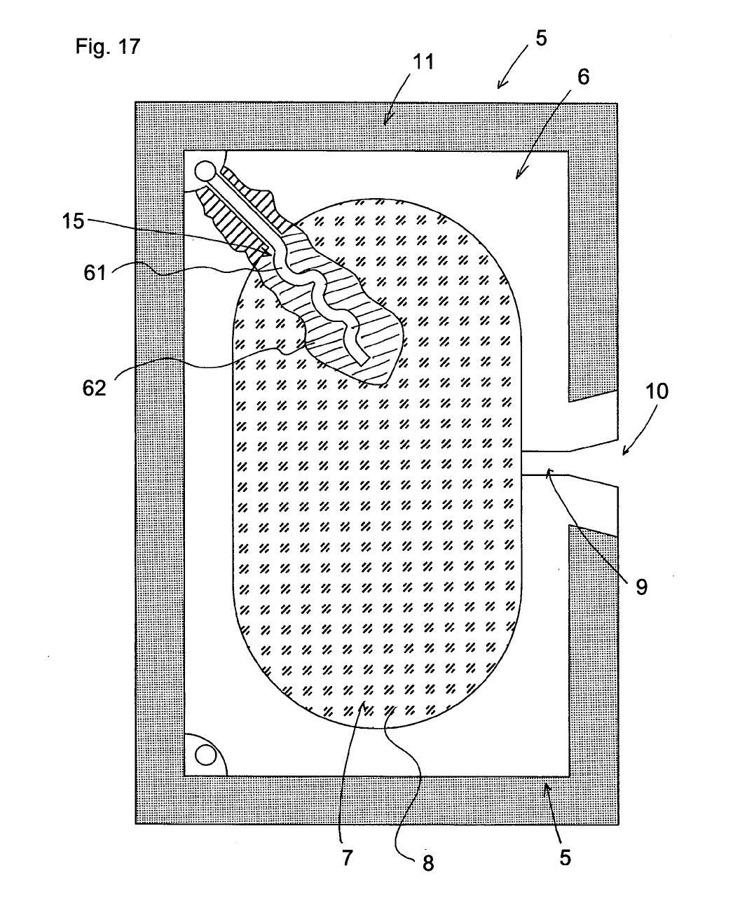

FIG. 17 shows a view in cross section of the device 4 shown in FIG. 13. The inside of one of the molten metal jet cutting units 5 is shown. The molten metal jet cutting unit 5 is held by the cutting unit holder 11. The housing 6 of the molten metal jet cutting unit 5 forms a fuel chamber 7 which is filled with the fuel material 8. A duct 9 connects the fuel chamber 7 with the nozzle opening 10. An electrical member 61 of the igniter 15 is located in the fuel chamber 7. The electrical member 61 is surrounded by magnesium 62. When the switch 49 of the igniter 15 is turned, the electrical member 61 will ignite the magnesium 62. The magnesium 62 will ignite the fuel material 8 so that molten metal is jetted out of the nozzle opening 10. This process is non-explosive.

FIG. 18 shows the device 4 of FIG. 13 attached to a support beam 3 of the support structure 2 of FIG. 1. The device 4 is located in the circular configuration 12 and clamps on the outer wall 64 of the support beam 3.

FIGS. 21 and 22 show the continuous cut 37 created in the support beam 3 by the device of FIG. 18.

The FIGS. 23-25 show a further embodiment of the device 4 according to the invention. The cutting unit holder 11 has two and only two holder elements 29. Each holder element 29 can hold a relatively large number of molten metal jet cutting units 5.

The FIGS. 26 and 27 show a further embodiment of the device according to the invention. The cutting unit holder 11 has a relatively large number of holder elements 29. Each holder element 29 holds one and only one molten metal jet cutting unit 5. In an alternative embodiment of the device 4, each holder element 29 holds multiple molten metal jet cutting units 5.

The FIGS. 28-31 show a further embodiment of the device 4 according to the invention and the continuous cut 37 created by said device 4. In the circular configuration 12 of the device 4;

a first part 71 of the nozzle openings 10 is positioned in a first circular configuration 24 in which the nozzle openings 10 of the first part 71 are directed to a first centre 25 of the first circular configuration 24,

a second part 72 of the nozzle openings 10 is positioned in a second circular configuration 26 in which the nozzle openings 10 of the second part 72 are directed to a second centre 27 of the second circular configuration 26, wherein the nozzle openings 10 of the second circular configuration 26 are located at a distance from the nozzle openings 10 of the first circular configuration 24, and

a third part 73 of the nozzle openings 10 is positioned in multiple intermediate configurations 70 in which the nozzle openings 10 of each intermediate configuration 10 are positioned between the nozzle openings 10 of the first part 71 and the second part 72 and are directed to a line 28 extending through the first centre 25 and second centre 27.

The method comprises cutting the cylindrical support beam 3 with a first circular cut 31 created by the nozzle openings 10 in the first circular configuration 24, a second circular cut 32 located at a distance from the first circular cut 31 and created by the nozzle openings 10 in the second circular configuration 26, and multiple intermediate cuts 33 created by the nozzle openings 10 in the intermediate configuration 70, which intermediate cuts 33 extend between the first circular cut 31 and the second circular cut 32. This type of cut can facilitate the disconnection of the part 18 of the sea platform to be removed. This type of cut can for example be used to allow that the weight of the part 18 of the sea platform to be removed collapses part between the first circular cut 31 and second circular cut 32.

The first circular cut 31 and the second circular cut 32 extend parallel towards each other. The first circular cut 31 and the second circular cut both extend perpendicular to a longitudinal axis 74 of the cylindrical support beam 3 on which the device 4 is attached. The intermediate cuts 33 extend from the first circular cut 31 until the second circular cut 33. The intermediate cuts 33 are positioned along a first intermediate line extending perpendicular to the first circular cut 31 and the second circular cut 32.

The FIGS. 32-34 show an alternative embodiment of the device 4 of FIG. 28 and the continuous cut 37 created by said device. The nozzle openings 10 in the intermediate configurations 70 form a zigzag configuration extending between the first circular configuration 24 and the second circular configuration 26.

The FIGS. 35-37 schematically show a further embodiment of the device 4 and method, wherein the support beam 3 is partly cut by the molten metal cutting jet units 5. FIG. 35 shows a support beam 3 having a partial cut 77 made with a different cutting technique, such as with diamond wire cutting, water jet cutting, or shear cutting. At a certain point, said cutting technique has failed, resulting in the partial cut 77.

The device 4 shown if the FIGS. 36 and 37 is used to complete the partial cut 77. In the device 4, nozzle openings 10 of the molten metal jet cutting units 5 are in the circular configuration 12 positioned to partly surround the support beam 3 to create a continuous cut 78 around part of the cylindrical support beam. In this embodiment shown, only two of the holder elements 29 are holding molten metal cutting jet units 5.

The device 4 also comprises nozzle openings 10 positioned along at least two lines extending from and transverse to the nozzle openings 10 partly surrounding the support beam 3. When the molten metal cutting jet units 5 are ignited, the nozzle openings 10 along said lines create continuous cuts 79 extending from and transverse to the continuous cut 78 created by the nozzle openings 10 partly surrounding the support beam 3 in order to connect the continuous cut 78 created by the nozzle openings 10 partly surrounding the support beam 3 with the partial cut 77 created by the different cutting technique. Said at least two lines extend in the same direction from the nozzle openings 10 partly surrounding the support beam 3.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language, not excluding other elements or steps). Any reference signs in the claims should not be construed as limiting the scope of the claims or the invention.

The mere fact that certain measures are recited in mutually different dependent claims does not indicate that a combination of these measures cannot be used to advantage.

1.-67. (canceled)

68. A method for removing at least part of a sea platform comprising a support structure with at least one cylindrical support beam located under water, which method comprises the steps of:
A. providing a device for cutting one of the at least one cylindrical support beams, said device comprising a plurality of molten metal jet cutting units to cut the cylindrical support beam, wherein each of the molten metal jet cutting units comprises a housing surrounding a fuel chamber filed with a fuel material, and a duct connecting the fuel chamber with a nozzle opening, which device comprises a cutting unit holder holding the plurality of molten metal jet cutting units to allow the positioning of the molten metal jet cutting units in a circular configuration in which the nozzle openings are directed to a centre of the circular configuration, wherein the device comprises a fastener to attach the molten metal jet cutting units in the circular configuration to the cylindrical support beam, and an igniter operatively connected to the molten metal jet cutting units to ignite the fuel material so that molten metal is jetted out of the nozzle openings;
B. attaching the device in the circular configuration under water to one of the at least one cylindrical support beams with the fastener, wherein the nozzle openings of the molten metal jet cutting units are directed to and at least partly surround said cylindrical support beam;
C. igniting the fuel material of the molten metal jet cutting units with the igniter to cut said surrounded cylindrical support beam with the molten metal jetted out of the nozzle openings;
D. lifting the disconnected part of the sea platform to be removed with a removal vessel provided near the support structure; and
E. transporting the disconnected part of the sea platform to be removed to a different location.

69. The method according to claim 68, wherein the method comprises before step C providing the removal vessel near the support structure and connecting the part of the sea platform to be removed to the removal vessel.

70. The method according to claim 69, wherein the provided removal vessel comprises a crane and the method comprises attaching the crane to the part of the sea platform to be removed.

71. The method according to claim 69, wherein the provided removal vessel comprises at least one support arm and the method comprises placing the at least one support arm under and in contact with at least part of the part of the sea platform to be removed.

72. The method according to claim 69, wherein during step C, the removal vessel remains connected to the part of the sea platform to be removed.

73. The method according to claim 69, wherein during step C, the removal vessel carries at least part of the weight of the part of the sea platform to be removed.

74. The method according to claim 68, wherein the steps A, B, and C are performed on multiple support beams of the support structure before the steps D and E are performed.

75. The method according to claim 68, wherein before step C, the support beam to which the device is attached has been partly cut with a different cutting technique, such as with diamond wire cutting, water jet cutting, or shear cutting.

76. The method according to claim 68, wherein in step C the fuel material of the molten metal jet cutting units undergo self-contained and self-sustained exothermic chemical reactions to jet molten metal out of the nozzle openings.

77. The method according to claim 68, wherein the cutting process in step C is non-explosive.

78. A device for cutting a cylindrical support beam which forms part of a support structure of a sea platform under water, which device comprises:
a plurality of molten metal jet cutting units to cut the cylindrical support beam, wherein each of the molten metal jet cutting units comprises a housing surrounding a fuel chamber filled with a fuel material, and a duct connecting the fuel chamber with a nozzle opening; and
a cutting unit holder holding the plurality of molten metal jet cutting units to allow the positioning of the molten metal jet cutting units in a circular configuration in which the nozzle openings are directed to a centre of the circular configuration,
a fastener to attach the molten metal jet cutting units in the circular configuration to the cylindrical support beam with the nozzle openings of the molten metal jet cutting units directed to and at least partly surrounding the cylindrical support beam, and
an igniter operatively connected to the molten metal jet cutting units to ignite the fuel material so that molten metal is jetted out of the nozzle openings.

79. The device according to claim 78, wherein in the circular configuration, the nozzle openings of the molten metal jet cutting units are positioned to create a continuous cut around at least part of the cylindrical support beam.

80. The device according to claim 78, wherein the cutting unit holder comprises multiple holder elements which are interconnected and pivotable relative to each other, and each holder element holds at least one molten metal jet cutting unit.

81. The device according to claim 78, wherein in the circular configuration, nozzle openings of the molten metal jet cutting units are positioned to fully surround the support beam in order to create a continuous cut around the entire cylindrical support beam.

82. The device according to claim 78, wherein in the circular configuration, nozzle openings of the molten metal jet cutting units are positioned to partly surround the support beam in order to create a continuous cut around part of the cylindrical support beam.

83. The device according to claim 78, wherein the igniter comprises a switch which is manually activatable by a diver or a switch which is activatabe by a ROV and wherein the igniter is an electrical igniter or an incendiary fuse igniter.

84. The device according to claim 78, wherein the fuel material is a solid metal material.

85. The device according to claim 78, wherein the fuel material comprises thermite or pyronol.

86. The device according to claim 78, wherein the fuel material of the molten metal jet cutting units undergo self-contained and self-sustained exothermic chemical reactions to jet molten metal out of the nozzle openings.

87. The device according claim 78, wherein the cutting process is non-explosive.
